(19) United States
(12) Patent Application Publication
(10) Pub. No.: US 2002/0082865 A1
(43) Pub. Date: Jun. 27, 2002

(54) Electronic patient healthcare system and method

(76) Inventors: Peter T. Bianco, Boston, MA (US); Randale Craig Sechrest, Missoula, MT (US); James L. Gribaudo, Roslindale, MA (US); Steven D. Peck, Hoboken, NJ (US); Ben Clemens, Rosendale, NY (US); Paul Emile Laquerre, Franklin, MA (US); Charles Freedom Eaton, Cambridge, MA (US); James Corbin Fitchett JR., Andover, MA (US); Thomas Arul, Malden, MA (US); Glen M. Tolchin, Purchase, NY (US); William Phillips, New York, NY (US); Gus Safary, Wood-Ridge, NJ (US)

Correspondence Address: NIXON PEABODY, LLP, 8180 GREENSBORO DRIVE, SUITE 800, MCLEAN, VA, 22102, US

(21) Appl. No.: 09/884,478

(22) Filed: Jun. 20, 2001

Related U.S. Application Data
(60) Provisional application No. 60/212,576, filed on Jun. 20, 2000.

(51) Int. Cl. G06F 17/60

(52) U.S. Cl. 705/2

(57) ABSTRACT

An electronic patient healthcare system for guiding a patient along a treatment pathway, related to a medical event, by educating and preparing the patient for the medical event and post-event recovery. The electronic healthcare system includes a healthcare information provider system with electronically displayable files, and a patient terminal device a display device adapted to display the electronically displayable files. In one embodiment, the electronically displayable files include a single electronically displayable file including a treatment pathway timeline display comprising a plurality of time-sequenced phase images corresponding to time-sequenced phases of health information, each of the time-sequenced phase images providing access to at least one of a pre-event set of electronically displayable files containing health information for preparing and educating the patient for the medical event and a post-event set of electronically displayable files containing health information for preparing and educating the patient for post-event recovery.

### BACKGROUND OF THE INVENTION

1. Field of the Invention

The present invention is directed to an electronic patient healthcare system, and more particularly, to such systems for guiding a patient through a medical event by educating and preparing the patient for the medical event and post-event recovery.

2. Description of Related Art

In the field of healthcare, patients obtain various services from healthcare practitioners such as doctors, nurses, therapists, etc. for various medical reasons such as ailments, surgery, therapy or other medical events such as pregnancy and childbirth. In this regard, each of the treatments associated with such medical events are frequently complex and difficult to understand for a lay person such as the patient. In addition, to successfully complete the treatment, there are often many related tasks that must be performed either prior to, or after the medical event. Information regarding the medical event, or a task that needs to be completed before or after the medical event, has been traditionally conveyed by the practitioner directly to the patient in various forms. In this regard, traditionally, methods of communication between the patient and the practitioner have primarily been in the form of telephone conversations, informational pamphlets, reminder notes, and other conventional methods.

However, this traditional method of communicating relevant necessary information to the patient results in inconsistent practices where some information may be unintentionally not provided to a particular patient. Moreover, this traditional method of communicating relevant information by handing out various pamphlets to the patient has also been found to be ineffective since these can be readily lost or misplaced. More importantly, the relevancy of these pamphlets are often not fully appreciated by the patients since they often discuss future information that is not particularly relevant to the patient at the present time. For instance, the patient may be provided with a pamphlet which explains intricate details of a particular medical event or recovery which occurs far in the future and numerous earlier steps must be completed prior to the medical event. Furthermore, due to the undesirable timing of the delivery of the medical event information to the patient, the patient often feels apprehension and confusion regarding the medical event or treatment.

In response, various devices, systems, and methods have been developed to alleviate some of the above noted issues regarding patient healthcare. In particular, U.S. Pat. No. 6,032,119 is directed toward the personalized display of health information. Specifically, the patient's medical records, standards of care for the condition, prescribed treatments and patient information are applied to a generalized health model of a disease to generate a personalized health model for the patient which includes a personalized display of a health condition of the patient. The personalized health model display comprises an HTML encoded image map of the body illustrating the health condition of the individual patient. Preferably, the data is collected from health provider sources and stored in a database on a server at a service provider site. The data is processed at the server and is displayed in the patient's home using a TV connected to a multimedia processor.

U.S. Pat. No. 6,161,095 is directed toward a treatment regimen compliance and efficacy with a feedback feature. In particular, the '095 patent allows for interaction between a community of individuals relating to compliance with a treatment regimen. Individuals interact with a protocol or intelligent message to provide assistance in all aspects of treatment, regimen compliance, data collection, supply or delivery, review and modification. These aspects can include (1) reminders regarding compliance with a selected treatment regimen for medication, physical therapy, psychological therapy, self-improvement, or some combination thereof, (2) data collection of facts regarding patient compliance, symptomatology, possible drug-interactions, or side effects of a medication if required by the treatment regimen, and other facts relevant to evaluation and possible modification of the treatment regimen; and (3) network integration with workstations for medical professionals to automate approvals and modifications, and refills and delivery of medication if required by the treatment regimen.

U.S. Pat. No. 6,085,752 relates to a method, apparatus and operating system for managing the administration of medicine and medical treatment regimens. In particular, the '752 patent relates to a medical monitoring device, operating system, and method for providing and managing administration of medical treatment regimen for treating a patient's medical conditions.

Still another reference, U.S. Pat. No. 6,014,630, is directed toward a customized system for providing procedure-specific patient education. In particular, the '630 patent produces an individualized patient educational report in hard copy form which is provided to patients about to receive medical procedures such as surgery. The printed report includes data relating to the particular medical procedure, the particular medical facility, and the particular physician. A typical individualized patient document would include the name of the procedure to be undertaken, the patient's and doctor's names, with necessary telephone numbers, tests which must be performed in advance, giving times and locations, questions on particular problems, such as allergies and whether existing medication should be discontinued, what the patient should do and expect on the day of the procedure, the type of anesthesia to be used, information as to after affects, discomfort, healing time and post-procedure medications, limitations of activities and necessary therapy after the procedure, dietary and nutritional information, problems which may arise and what to do about them, and the date and place of the first post-procedure visit with the doctor.

However, there is still a need for an interactive, electronic patient healthcare system providing a full array of education and preparation tools for guiding a patient through a medical event.

### SUMMARY OF THE INVENTION

In view of the foregoing, an exemplary advantage of the present invention is that it provides a system and method for educating and preparing the patient for a medical event.

Another exemplary advantage of the present invention is that it provides such education and preparation to the patient in a time sequenced manner.

Still another exemplary advantage of the present invention is that it provides a treatment pathway that a patient can follow to facilitate effective treatment.

Yet another exemplary advantage of the present invention is that it provides an electronic patient healthcare system which permits the patient to more effectively and sequentially manage the process of preparing and educating themselves for a medical event and post-event recovery.

Still another exemplary advantage of the present invention is that it provides an on-line electronic graphical interface which permits the patient or his/her medical practitioner to move along a treatment pathway in a step-by-step fashion sequentially completing tasks.

The above noted advantages and other features are provided by an electronic patient healthcare system for guiding a patient along a treatment pathway, related to a medical event, by educating and preparing the patient for the medical event and post-event recovery. The electronic healthcare system may include a healthcare information provider system including a storage device and electronically displayable files, and a patient terminal device in electronic communication with the healthcare information provider system and including an input device and a display device adapted to display the electronically displayable files. The electronically displayable files in accordance with one exemplary embodiment the present invention contain health information associated with the medical event which are retrievably stored on the storage device, the storage device further including a registered patient database for storing information regarding patients being guided by the electronic patient healthcare system and a registered practitioner database for storing information regarding practitioners treating the patients being guided by the electronic patient healthcare system. In addition, the electronically displayable files in accordance with the present invention include at least one pre-event set of electronically displayable files containing health information for preparing and educating the patient for the medical event, and at least one post-event set of electronically displayable files containing health information for preparing and educating the patient for post-event recovery so as to guide the patient along the treatment pathway, at least one of the pre-event and post-event sets of files including a task file that instructs the patient to perform a predetermined task, the predetermined task including at least two of scheduling an appointment with a medical professional, purchasing a medical product, taking a medical quiz, and evaluating at least one of a medical practitioner and a medical service facility.

In accordance with one embodiment of the present invention, the electronically displayable files include a single electronically displayable file including a treatment pathway timeline display comprising a plurality of time-sequenced phase images corresponding to time-sequenced phases of health information thereby illustrating the treatment pathway. In this regard, each of the plurality of time-sequenced phase images may include at least one electronic link to one of the pre-event set of files and the post-event set of files, and the patient can access the health information of a particular time-sequenced phase by interacting with the corresponding time-sequenced phase image. In accordance with another embodiment of the present invention, the task file includes a patient confirmation sub-file that requires the patient to interactively confirm completion of the predetermined task using the input device of the patient terminal device and communicate the confirmation with the healthcare information provider system. In accordance with still another embodiment of the present invention, at least one of the pre-event and post-event sets of files includes a calendar file that displays a schedule of time specific events associated with the treatment pathway, the calendar file adapted to be modified by the patient using the input device of the patient terminal device.

The healthcare information provider system may also include an electronically displayable duplicate account file containing input fields for receiving account information relating to an authorized user to create a duplicate account for permitting the authorized user to access and modify the patient's treatment pathway. In accordance with yet another embodiment of the present invention, each of a patient's time-sequenced phase images is adapted to be modified by a medical practitioner treating the patient being guided by the electronic patient healthcare system.

In accordance with another exemplary embodiment of the present invention, a system for displaying health information capable of guiding a patient along a treatment pathway is provided where the electronically displayable files include a single electronically displayable file including a treatment pathway timeline display comprising a plurality of time-sequenced phase images corresponding to time-sequenced phases of health information, each of the time-sequenced phase images providing access to at least one of a pre-event set of electronically displayable files containing health information for preparing and educating the patient for the medical event and a post-event set of electronically displayable files containing health information for preparing and educating the patient for post-event recovery so as to guide the patient along the treatment pathway.

In accordance with another exemplary aspect of the present invention, method is provided for guiding a patient along a treatment pathway associated with a medical event by providing health information to educate and prepare the patient for the medical event and post-event recovery. The method includes the steps of generating, at least one pre-event set of electronically displayable files containing health information for preparing and educating the patient for the medical event, and at least one post-event set of electronically displayable files containing health information for preparing and educating the patient for post-event recovery, displaying a single electronically displayable file including a treatment pathway timeline display comprising a plurality of time-sequenced phase images corresponding to time-sequenced phases of health information to illustrate the treatment pathway, and permitting the patient to view the treatment pathway timeline display and access the health information of a particular time-sequenced phase by interacting with the corresponding time-sequenced phase image. Each of the time-sequenced phase images provide access to at least one of a pre-event set of electronically displayable files containing health information for preparing and educating the patient for the medical event and a post-event set of electronically displayable files containing health information for preparing and educating the patient for post-event recovery so as to guide the patient along the treatment pathway.

In accordance with another exemplary embodiment of the present invention, the method further includes the steps of providing the patient with a medical practitioner code designating the medical practitioner conducting the medical event and requiring the patient to input the medical practitioner code into an electronically displayable file containing a code input field and transmitting the code to the healthcare information provider system.

In accordance with one exemplary embodiment of the present method, at least one of the pre-event and post-event sets of files may include a task file that instructs the patient to perform a predetermined task. In this regard, the predetermined task may include at least three of reading a medical information file, taking medication, scheduling an appointment with a medical professional, purchasing a medical product, taking a medical quiz, and evaluating at least one of a medical practitioner and a medical service facility. In accordance with another embodiment, at least one of the pre-event and post-event sets of files may also include a calendar file that displays a schedule of time specific events associated with the treatment pathway, the calendar file being adapted to be modified by the patient using the input device of the patient terminal device. In addition, another embodiment of the present invention may further include the step of providing an electronically displayable duplicate account file containing input fields for receiving account information relating to an authorized user to create a duplicate account for permitting the authorized user to access and modify the patient's treatment pathway.

Still another exemplary aspect of the present invention is to provide an information storage media with instructions for performing the above described method for guiding a patient along a treatment pathway associated with a medical event.

These and other features and advantages of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of an electronic patient healthcare system.

FIG. 2A is an enlarged schematic view of the electronically displayable files as shown in FIG. 1.

FIG. 2B is a more detailed view of the pre-event set of electronically displayable files of FIG. 2a.

FIG. 3 is a treatment pathway timeline display in accordance with one embodiment of the present invention.

FIG. 4 is a flowchart illustrating a method for guiding a patient along a treatment pathway in accordance with one embodiment of the present invention.

FIG. 5 is an illustration of a home page of one embodiment of the present invention as implemented via the Internet.

FIG. 6A shows a web page that provides physician biographical and practice information.

FIG. 6B shows an additional information page with a map that may be linked to the web page of FIG. 6A.

FIG. 7A shows a storefront page for an on-line store.

FIG. 7B shows a listing of products that may be purchased through the on-line store.

FIG. 7C shows a product page that provides information regarding a particular product.

FIG. 8A shows a procedure listing page accessible via the home page of FIG. 5.

FIG. 8B shows an informational web page of a procedure selected from the procedure listing page of FIG. 8A.

FIG. 8C shows a multimedia video clip which may be viewed by the patient.

FIG. 9A shows an identification page that may be used for registering with the healthcare information provider system in accordance with one embodiment of the present invention.

FIG. 9B shows a registration page in accordance with one embodiment which requires a physician code.

FIG. 9C shows a personal profile page for providing personal information to the healthcare information provider system.

FIG. 9D shows a web page that may be used to create a user name and a password.

FIG. 9E shows confirmation page indicating a patient's completion of the registration process.

FIG. 9F shows a sign in page in accordance with one embodiment for accessing the healthcare information provider system in accordance with the present invention.

FIG. 10A shows a personalized web page accessible through the healthcare information provider system that has been tailored to correspond to the medical event of the registered patient.

FIG. 10B shows an appointment page for scheduling an appointment.

FIG. 10C shows a task page for entering a new task to the personalized web page.

FIG. 11A shows an inbox provided in a message center in accordance with one embodiment of the present invention.

FIG. 11B shows a sample message in the inbox.

FIG. 11C shows a reply to the sample message of FIG. 11B.

FIG. 11D shows a new message being composed in the message center.

FIG. 11E shows a discussions web page in the message center in accordance with one embodiment.

FIG. 11F shows a creation of a new topic post in the discussions page of the message center.

FIG. 12 shows the personalized web page of FIG. 10A but with a monthly calendar.

FIGS. 13A-13D each show a portion of treatment pathway timeline display that is displayed on a pathway page in accordance with one embodiment of the present invention.

FIG. 14A shows an informational web page that may be viewed by the patient.

FIG. 14B shows an enlarged image page that may be viewed by the patient.

FIG. 15 shows an appointment page for scheduling an appointment.

FIG. 16 shows one embodiment of a self assessment quiz.

FIG. 17A shows an exercise listing page that lists various pre-operative exercises.

FIG. 17B shows an exercise web page explaining details of a particular sample exercise.

FIG. 18 shows an evaluation web page for evaluating the physician.

FIG. 19 shows one example of an equipment list page that lists various products that the patient should purchase prior to the medical event.

FIG. 20 shows a hospital evaluation page for evaluating the patient's hospital.

FIG. 21 shows a do's and don'ts page that list additional information useful for recovery.

FIG. 22A shows a create duplicate account page in accordance with one embodiment of the present invention.

FIG. 22B shows a confirmation page confirming the creation of a duplicate account.

FIG. 23 shows a help page for receiving on-line help.

FIG. 24A shows a physician registration form in accordance with one embodiment.

FIG. 24B shows a personal information form for the medical practitioner in accordance with one embodiment.

FIG. 24C shows a practice information form for the medical practitioner in accordance with one embodiment.

FIG. 24D shows a password page for creating the medical practitioner's password.

FIG. 24E shows an account confirmation page for confirming the physician's account information.

FIG. 25 shows a physician center page in accordance with one embodiment of the present invention.

FIG. 26 shows an evaluations list page in accordance with one embodiment of the present invention.

FIGS. 27A-27C each show a patient response page as viewable by the medical practitioner.

FIG. 28 shows an example of a reference page that may be accessed by the medical practitioner.

### DETAILED DESCRIPTION OF THE PREFERRED EMBODIMENT

As will be described in further detail hereinbelow, the present invention provides an electronic patient healthcare system 1 and method for guiding a patient through a medical event by educating and preparing the patient for the medical event and post-event recovery. In this regard, it should be noted that the term “medical event” should be understood to generally mean any type of medical procedure or medically related event. For instance, the medical event may be an operation, treatment, testing, etc., or an event such as pregnancy or birth of a baby. Of course, these are provided merely as examples only and the present invention should not be limited thereto but should be understood generally to encompass any type of medical events.

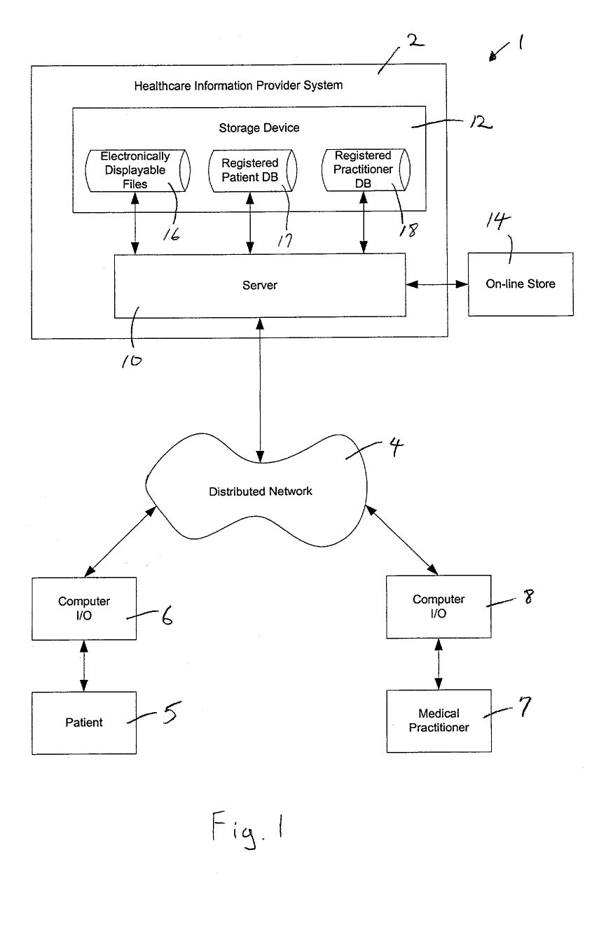

FIG. 1 schematically illustrates one implementation of the electronic patient healthcare system 1 in accordance with one embodiment of present invention which includes a healthcare information provider system 2 that is electronically linked to a distributed network 4 to guide one or more patients, such as patient 5, along a treatment pathway by educating and preparing the patient 5 for the medical event and post-event recovery. It should be understood that the term “treatment pathway” generally refers to the series of time-sequenced steps or phases explained in further detail below that facilitate successful preparation, education and treatment of a patient and post-event recovery. In addition, as also will be discussed in further detail below, the present invention allows one or more medical practitioners, such as medical practitioner 7, and/or authorized colleagues of the medical practitioners, to access the healthcare information provider system 2 for patient monitoring and communication purposes as described in detail below. Of course, additional patients and medical practitioners can also access and use the healthcare information provider system 2 in accordance with the present invention as well but are omitted to simplify the discussion herein.

As can be seen in FIG. 1, patient 5 and medical practitioner 7 access the healthcare information provider system 2 through the distributed network 4 using a terminal device such as computers 6 and 8 respectively which are in electronic communication with the distributed network 4. In this regard, the computers 6 and 8 include an input device (not shown) and a output device such as a display device (not shown). Input devices can be a mouse, a keyboard or the like while the output device is preferably a display device such as a monitor or an LCD screen. Of course, other input and output devices can also be used as well. In this regard, patient 5 and the medical practitioner 7 may access the healthcare information provider system 2 through the distributed network 4 using any type of computing device or data terminal such as a personal computer, a portable computer, a dumb terminal, a thin client, a hand-held device, a wireless phone, or any combination of such devices.

It should also be appreciated by one of ordinary skill in the art that the distributed network 4 can be any type of a communications network such as the Internet, local area network (LAN), a wide area network (WAN), direct computer connections, or the like. The communication between the healthcare information provider system 2 and patient 5 and the medical practitioner 7 may be established using any type of communication hardware and protocols which are already well known in the art. For instance, such communication can be accomplished over electric cable, fiberoptic cable, or any other cable, or in a wireless manner using radio frequency, infrared, or other technologies.

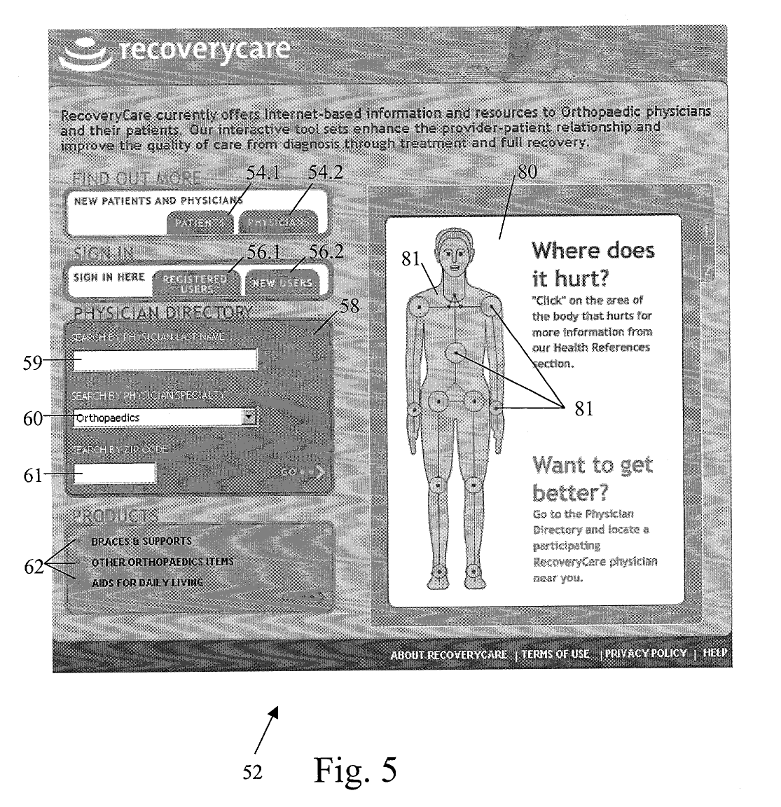

In the present illustrated embodiment of FIG. 1, the healthcare information provider system 2 includes a server 10 with databases and files described herein below for guiding patient 5 along a treatment pathway by educating and preparing the patient for the medical event and post-event recovery. It should be initially noted that whereas a single server 10 is illustrated in the present embodiment, it should be appreciated that the server 10 can also be multiple computers at a single or multiple locations. For example, a server 10 may be comprised of plurality of redundant computers located in different locations to facilitate scalability. In this regard, part or all of the healthcare information provider system may be provided directly on the medical practitioner's facility. The details of accessing the information provided by the healthcare information provider system 2 is discussed in further detail below relative to FIGS. 5-28 which illustrate a specific example of electronic patient healthcare system 1 implemented over the Internet also known as the “world wide web”.

Referring again to FIG. 1, the healthcare information provider system 2 of the electronic patient healthcare system 1 includes a storage device 12 which is electronically connected to the server 10. The storage device 12 is adapted to store therein electronically displayable files 16 which may be in a database or arranged in any appropriate manner to allow retrievable access to the files. The electronically displayable files 16 in accordance with the present invention contain health information associated with the medical event, the details of which are provided in a subsequent discussion.

As can also be seen in FIG. 1, the storage device 12 further includes a registered patient database 17 for storing information regarding patient 5 accessing the healthcare information provider system 2 and being guided by the electronic patient healthcare system 1. In this regard, the registered patient database 17 stores patient specific information such as the patient's doctor or medical practitioner, diagnosis and recommended treatment, schedules, and a record of the patient's current phase in the treatment pathway described in detail below.

In addition, the storage device 12 further includes a registered practitioner database 18 for storing information regarding practitioners such as medical practitioner 7 treating patient 5. More specifically, the registered practitioner database 18 may contain biographical, specialty, and other information related to various medical practitioners -registered with the healthcare information provider system 2. The registered practitioner database 18 may be searchable based on the registered practitioners name, specialty, location or other parameters. This may be obtained by using a search engine well known in the art. Moreover, when a registered practitioner is found in the registered practitioner database 18, such information may be associated with other types of information such as the practitioner's location, directions, and other information via links.

Moreover, the server may also be linked to an on-line store 14 that allows the patient 5 to purchase products and/or services associated with the medical event and recovery. It should be noted that whereas in the present illustrated embodiment, the on-line store 50 is provided by a third party, in other embodiments, the on-line store 14 may be operated directly by the healthcare information provider system 2.

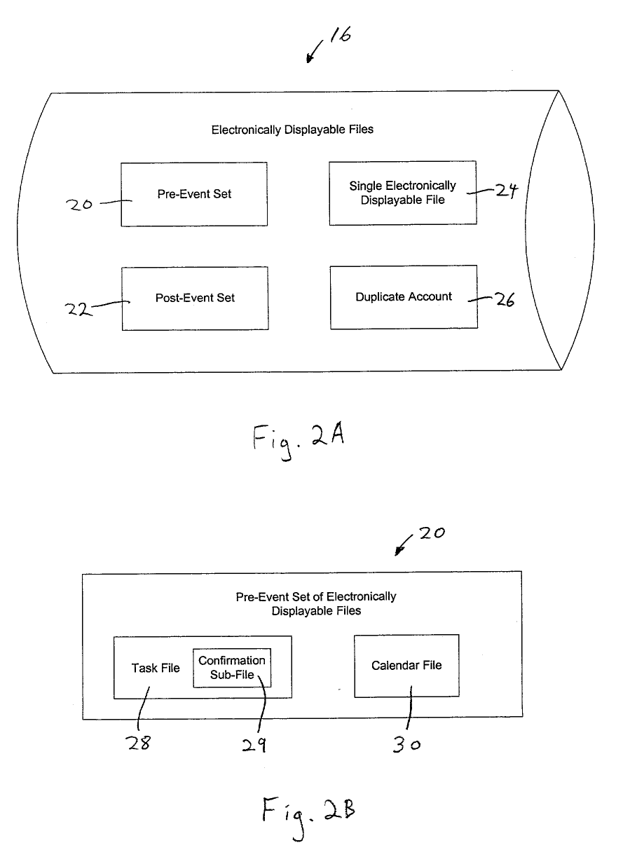

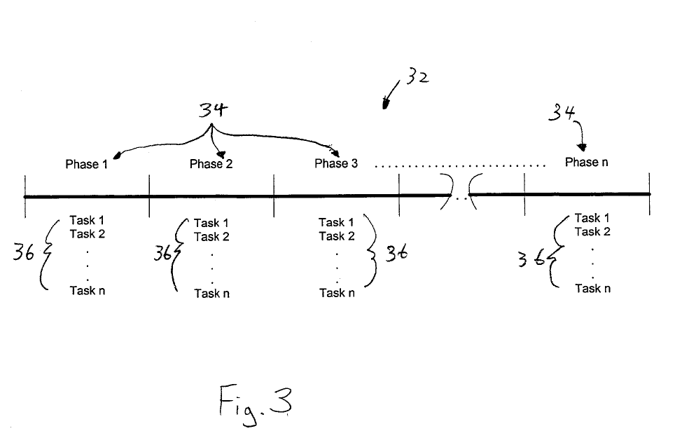

FIG. 2A illustrates the electronically displayable files 16 of FIG. 1 in further detail in accordance with one embodiment of the present invention. As can be seen, the electronically displayable files 16 includes at least one pre-event set 20 of electronically displayable files containing health information for preparing and educating the patient for the medical event. In addition, the electronically displayable files 16 includes at least one post-event set 22 of electronically displayable files containing health information for preparing and educating the patient for post-event recovery so as to guide the patient along the treatment pathway. At least one of the pre-event set 20 and post-event set 22 of files include a task file that instructs the patient to perform a predetermined task as discussed below.

In accordance with the illustrated embodiment of FIG. 2A, the electronically displayable files 16 also include a single electronically displayable file 24 including a treatment pathway timeline display discussed in further detail below relative to FIG. 4 that illustrates the patient's treatment pathway. Furthermore, the electronically displayable files 16 of the healthcare information provider system 2 may also include an electronically displayable duplicate account file 26 containing input fields for receiving account information relating to an authorized user to create a duplicate account for permitting the authorized user to access and modify the patient's treatment pathway.

An enlarged schematic view of the pre-event set 20 of electronically displayable files in accordance with one embodiment of the present invention is shown in FIG. 2B. As can be seen, the pre-event set 20 of files include at least one a task file 28 that instructs the patient to perform a predetermined task. It should be noted that many of the electronically displayable files containing health information may be considered task files since the file either contains an explicit instruction to perform a task and/or contains health information/input fields which the patient has been requested to review and/or complete. Such a task may include scheduling an appointment with a medical practitioner, purchasing a medical product, taking a medical quiz, and evaluating a medical practitioner or a medical service facility. Of course, task file 28 may instruct the patient to perform any task that will facilitate successful treatment of the patient such as reading a health information document, arranging a ride, taking medication etc. In addition, the task file 28 may include a confirmation sub-file 29 that requires the patient to interactively confirm completion of the predetermined task associated with the task file 28. Such confirmation may be attained by patient 5 using the input device of the patient terminal device such as the computer 6 shown in FIG. 1 and communicated to the healthcare information provider system 2. Furthermore, the illustrated embodiment of the pre-event set 20 of files includes a calendar file 30 that displays a schedule of time specific events associated with the treatment pathway on the patient's computer 6. The calendar file 30 is adapted to be modified by patient 5 using the input device of the computer 6. In a similar manner, the post-event set 22 of electronically displayable files may also be provided with such a task file, confirmation sub-file, and/or the calendar file.

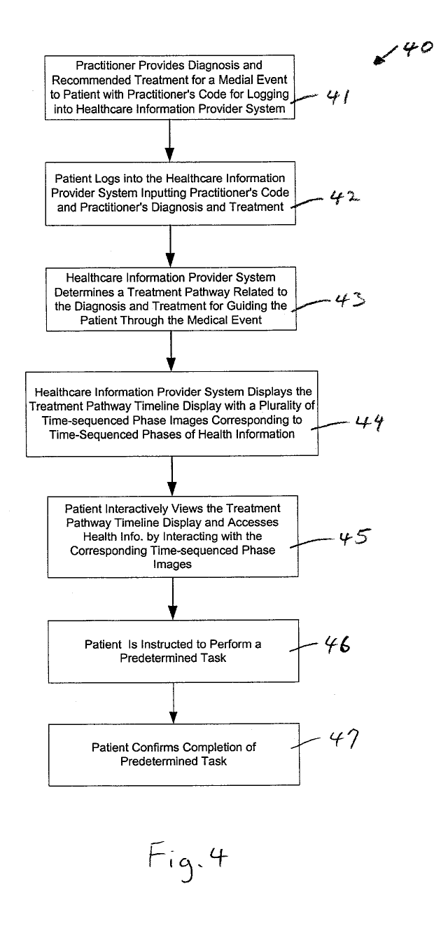

As previously noted, the single electronically displayable file 24 includes a treatment pathway timeline display that illustrates the patients treatment pathway specifically tailored to the medical event of the patient. One embodiment of treatment pathway timeline display 32 that illustrates the patient's treatment pathway is shown in FIG. 3. As can be seen, the treatment pathway timeline display 32 includes a plurality of time-sequenced phase images 34 corresponding to time-sequenced phases of health information for preparing and educating the patient for the medical event and a post-event recovery thereby providing the treatment pathway for a given medical event for the patient 5. In this regard, it should be understood that as used herein, phase images broadly refer to any visual representation displayed that segments the treatment pathway into defined time-sequenced regions. For instance, phase images may be represented by text and/or any graphical representation including symbols, border lines, shading, coloring, etc. which are displayed for the patient in a manner that clearly distinguishes the phases along the treatment pathway.

Each of the plurality of time-sequenced phase images 34 in the illustrated embodiment include at least one text field generally describing the tasks to be completed in the particular phase. Each text description preferably forms an electronic link 36 providing access to a task file 28 in one of the pre-event set 20 of files and the post-event set 22 of files. Of course, a graphical icon may be included instead of, or in addition to the text field. Again, it should be noted that the pre-event set 20 of electronically displayable files contain health information for preparing and educating the patient for the medical event while the post-event set 22 of electronically displayable files contain health information for preparing and educating the patient for post-event recovery. The patient 5 can access the health information associated with a particular time-sequenced phase by interacting with the corresponding time-sequenced phase image 34, such interaction again being possible via the distributed network 4 using computer 6 in the present illustrated embodiment. It should be understood that the post-event set 22 of files may be accessible via links positioned in phases anywhere along the treatment pathway timeline display 32 including prior to the actual medical event. Thus, in accordance with the present invention, the time-sequenced phase images of the treatment pathway timeline display 32 allows the patient to be guided in a step-by-step manner through the medical event thereby increasing the likelihood of successful treatment and recovery of the patient. In addition, because each patient and his/her medical event may be slightly different from the norm, each of a patient's time-sequenced phase images may be modified by a medical practitioner treating the patient being guided by the electronic patient healthcare system 1.

FIG. 4 illustrates a method 40 in accordance with one embodiment of the present invention for using the above described electronic patient healthcare system 1 of FIG. 1 to guide a patient along a treatment pathway associated with a medical event through the provision of health information designed to educate and prepare the patient for the medical event and post-event recovery. As can be seen, the illustrated method 40 includes step 41 in which a medical practitioner such as a doctor, nurse or other medical professional, provides a diagnosis of a patient's ailment or condition and recommends an appropriate treatment to the patient so that there is a medical event which the patient should prepare for. Also in step 41, the medical practitioner also provides a practitioner's code to the patient for logging into the healthcare information provider system 2 as described above.

In step 42, the patient registers and logs into the healthcare information provider system 2 by inputting the practitioner's code, diagnosis and recommended treatment. In response to the patient's registration, the healthcare information provider system 2 in step 43 determines a treatment pathway correlated to the diagnosis and the recommended treatment. In step 44, the healthcare information provider system accesses the single electronically displayable file 24 of FIG. 2A and displays the treatment pathway timeline display 32 of FIG. 3 comprising the plurality of time-sequenced phase images 34 corresponding to time-sequenced phases of health information to illustrate the treatment pathway associated with the patient's medical event. As previously described relative to FIG. 3, each of the time-sequenced phase images 34 include a plurality of electronic links 36, each link providing access to a task file 28 in at least one of a pre-event set 20 of electronically displayable files containing health information for preparing and educating the patient for the medical event, and a post-event set 22 of electronically displayable files containing health information for preparing and educating the patient for post-event recovery.

In step 45, the patient interactively views the treatment pathway timeline display 32 and accesses the health information of a particular time-sequenced phase by interacting with the corresponding time-sequenced phase image 34 through one or more of the plurality of electronic links 63 thereunder. Upon such interaction, the patient is instructed to perform a predetermined task in step 46. As previously noted, such a predetermined task can include scheduling an appointment with a medical practitioner, purchasing a medical product, taking a medical quiz, and evaluating a medical practitioner or a medical service facility. Other task can include reading a health information document, arranging a ride, taking medication etc. or any other task that will facilitate successful treatment of the patient. In step 47, the patient confirms the completion of the predetermined task using, for instance, the input device of the computer 6 shown in FIG. 1. In this manner, the patient 5 may be guided through the medical event in a step-by-step manner, following the treatment pathway thereby increasing the likelihood of a successful medical event and post-event recovery while reducing the patient's stress and apprehension. Of course, it should be also appreciated that various steps may be added or deleted to the method 40 which is merely provided as one example of a method in accordance with the present invention.

FIGS. 5-28 discussed hereinbelow show various screen shots of electronically displayed files (referred to hereinbelow as web pages) or portions thereof, web pages illustrating various aspects of one example of the present invention as implemented on the Internet or the “world wide web” a.k.a. the web. In this regard, FIG. 5 shows the home page 52 which may be accessed and used to facilitate the effective treatment of a patient by guiding the patient through a medical event by educating and preparing the patient for the medical event and post-event recovery. It should initially be noted however, that the various web pages shown and discussed are merely one example and the present invention may be implemented through the Internet, or any other distributed network in a different manner. Moreover, the example as herein discussed is specifically tailored to the medical field of orthopedics and thus, is most useful to orthopedic physicians and their patients. However, in alternative implementations of the present invention, the medical event to which the present invention is applied may be varied widely such as surgery in other medical fields, non-surgical procedures and treatment, and natural events such as pregnancy, childbirth and others. In addition, it should be noted that in the present illustrated and discussed embodiment, the medical practitioner is a physician in the field of orthopedics and thus, the various web pages refer to a physician. However, it should again be understood that the present invention is not limited thereto and the term medical practitioner as used herein is not limited to physicians but can be any practitioner that provides health services to patients.

The general aspects of system implementation has already been described above in FIGS. 1-3 in which a healthcare information provider system 2 is accessed by the patient 5 and the medical practitioner 7 via the distributed network 4, which in this case is the Internet, using computers 6 and 8 respectively. Turning now to the specific example of web implementation of the present invention as shown in FIG. 5, the illustrated home page 52 of FIG. 5 is found at the Internet address www.recoverycare.com and is the home page of recoverycare^{sm} which provides Internet based information and resources to orthopedic physicians and their patients in accordance with the present invention. Of course, the design and implementation of web pages and web sites using various tools including computer programming language such as HTML and JAVA® are well known in the art and need not be discussed in detail here.

As can be seen in FIG. 5, the home page 52 that provides a user interface to the functions and features of the healthcare information provider system allows new patients and physicians to find out more information regarding the services of the healthcare information provider and to register as a new patient or physician using the links 54.1 (for patients) and 54.2 (for physicians). In addition, the home page 52 also allows already registered users to log into the healthcare information provider system 2 by clicking on link 56.1 while new users can register in the manner described below by clicking on link 56.2. The details of login and registration are discussed in further detail later.

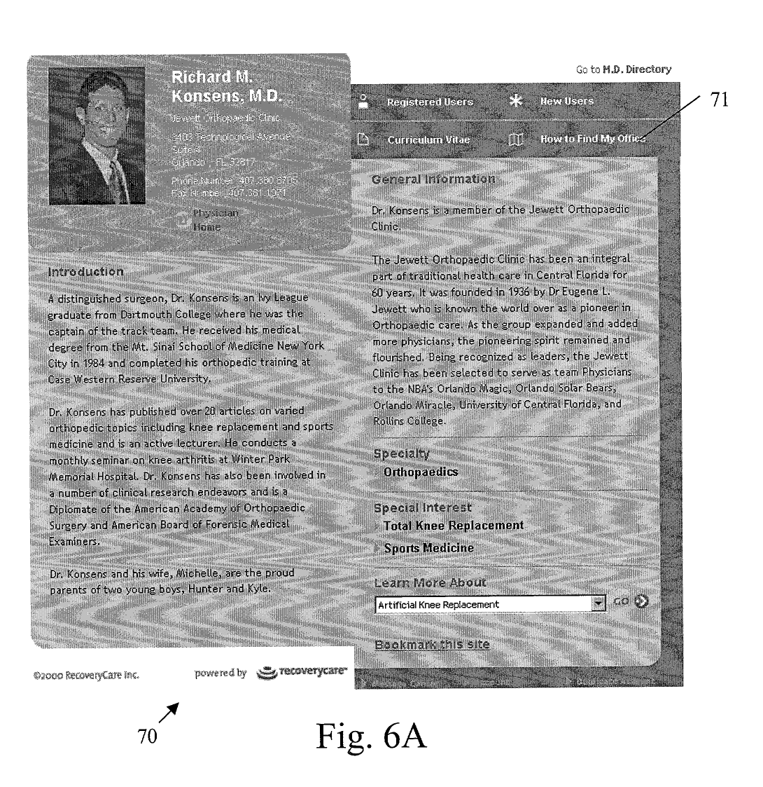

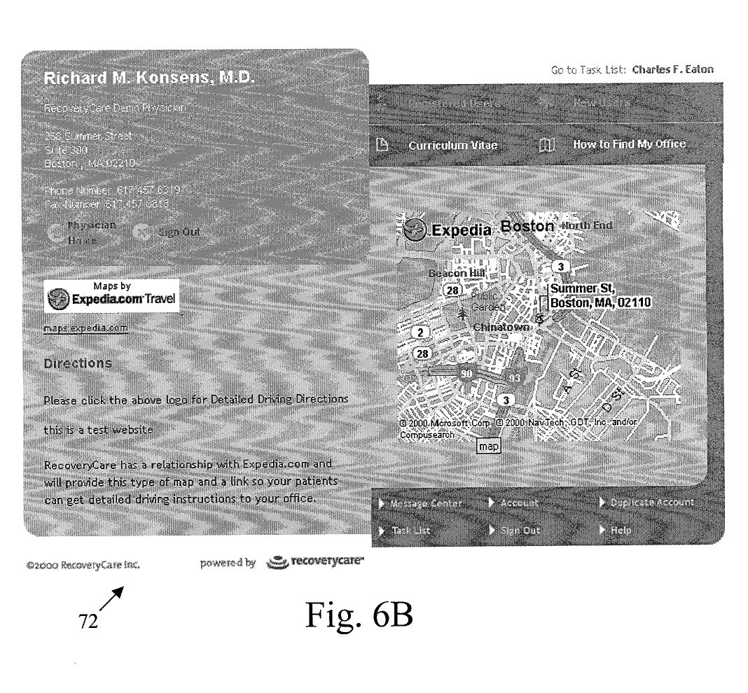

In addition, the home page 52 shown in FIG. 5 includes other features that are readily useable by anyone visiting the home page 52, even if they are not registered with the healthcare information provider system 2. These features include a physicians directory 58, a graphical diagnostic 80, and product links 62 which link to the on-line store similar to that discussed previously. In particular, the directory feature 58 allows the user to search for a physician by his/her last name via field 59, by the physician's specialty via drop down menu 60, or by the geographical location of the physician via field 61. The physicians directory accesses and searches the registered practitioner database 18 shown in FIG. 1 to provide physician biographical and practice information such as that shown in web page 70 of FIG. 6A. Such additional information may include maps and/or directions such as that shown in web page 72 of FIG. 6B which may be accessed by link 71. The searchable features of the physicians directory 58 allows a visitor to quickly find a physician and further provides a marketing tool for the physician registered with the healthcare information provider system 2.

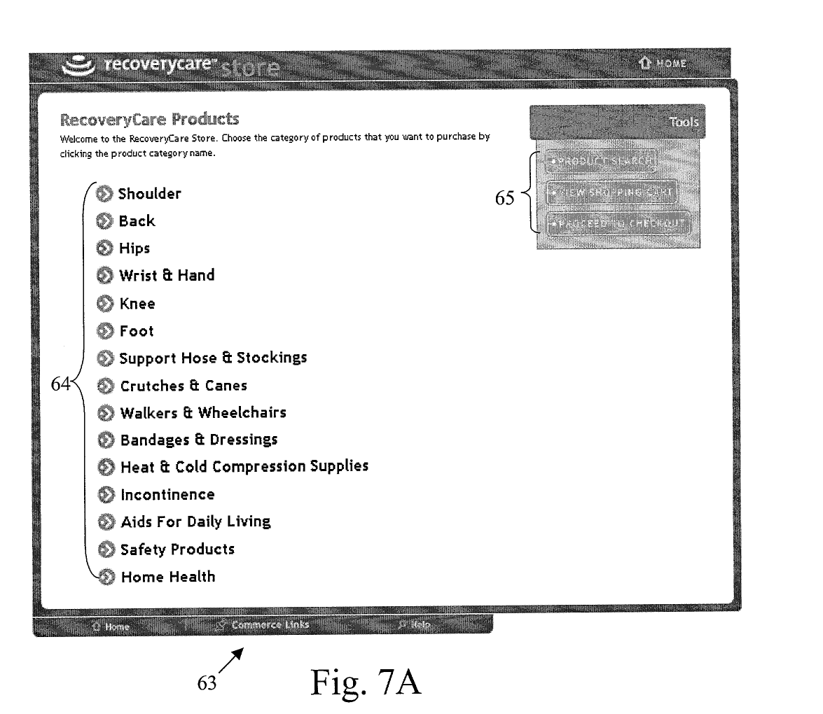

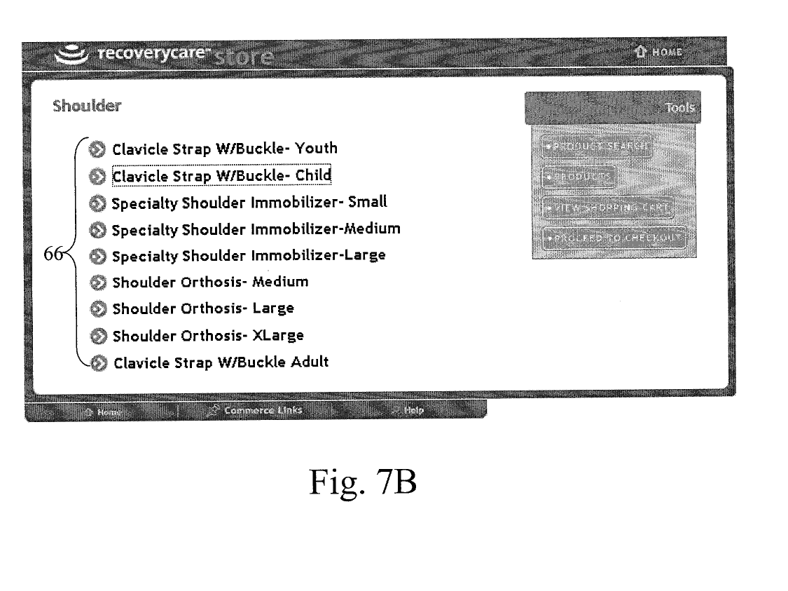

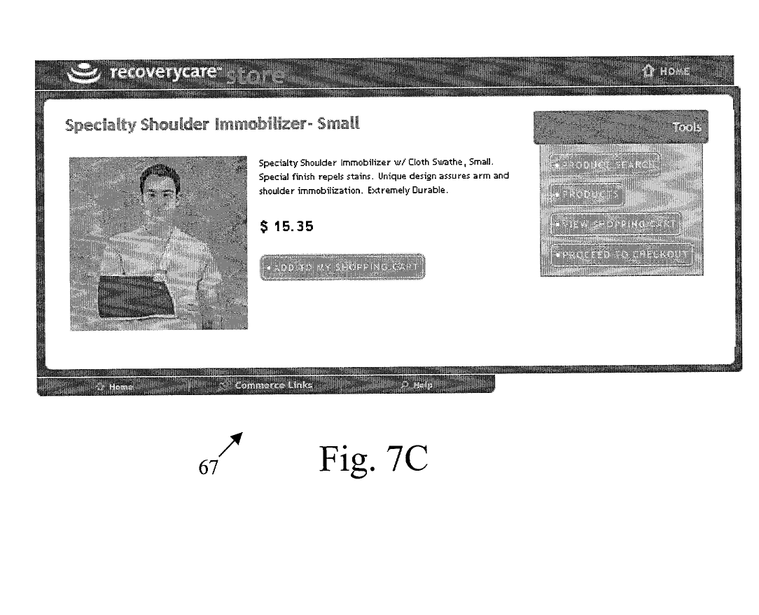

The product links 62 access the on-line store with a storefront page 62 as shown in FIG. 7A which lists various categories 64 of products for viewing and purchase. Again, the on-line store associated with the storefront page 62 may or may not be implemented by the healthcare information provider system 2. Various tools 65 may be provided to allow quick identification and purchase of a desired product on-line. In addition, each of the categories 64 may be a link to a listing of products 66 for a particular given category as shown in FIG. 7B. Each product 66 may, in turn, be a link to a product page 67 shown in FIG. 7C that provides additional information and pricing information regarding the product.

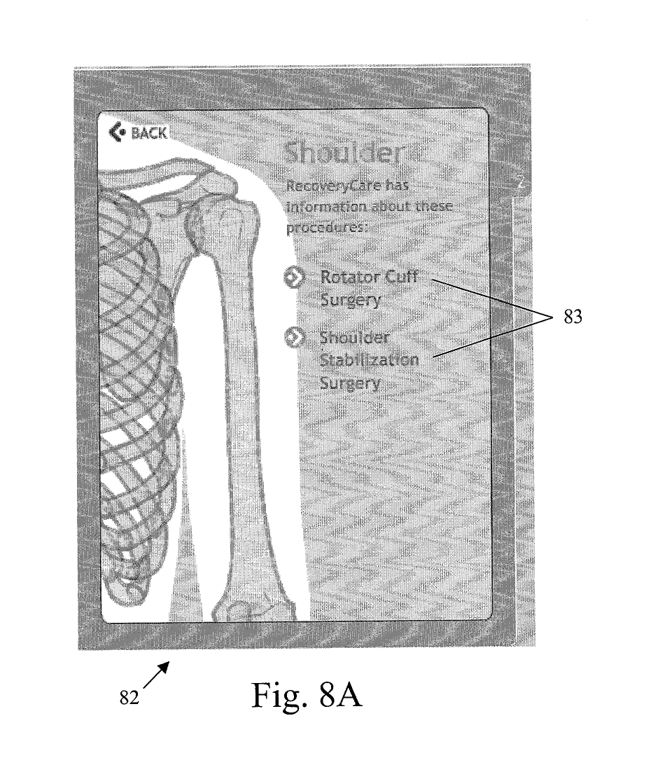

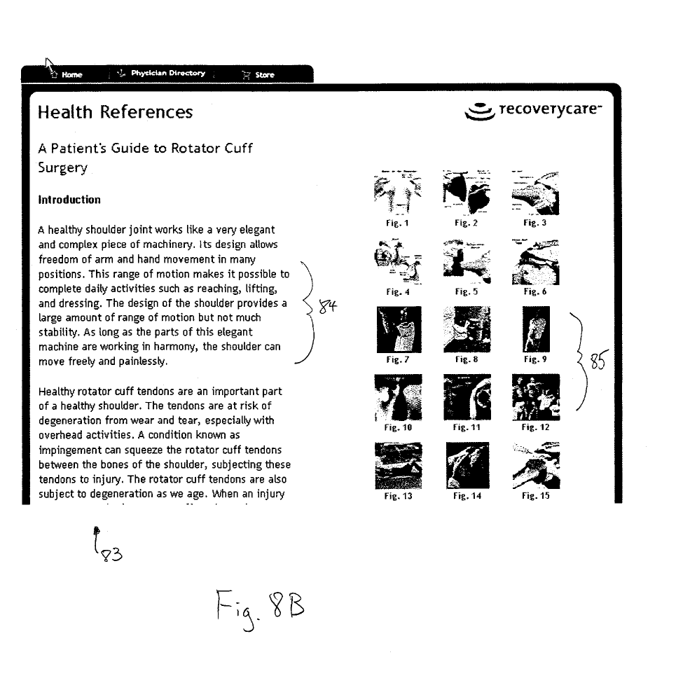

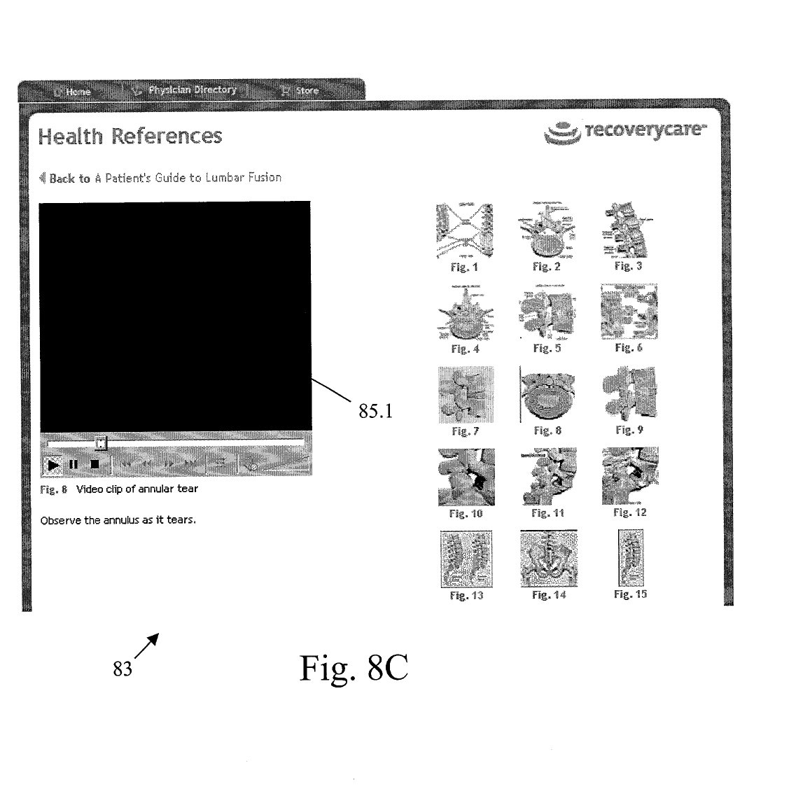

Referring again to FIG. 5, the graphic diagnostic 80 allows the visitor to the home page 52 to obtain information regarding the visitor's medical condition, such as the visitor's orthopedic medical condition in the present example. In particular, by clicking on one of the trigger fields 81.1 associated with a location on the body graphic 81, a visitor to the home page 52 is linked to a procedure listing page 82 shown in FIG. 8A which lists via links 83, the various procedures for which information is available through the healthcare information provider system 2. In this regard, if the link for the “Rotator Cuff Surgery” is selected, an informational web page 83, as shown in FIG. 8B, is displayed for the visitor to provide various information regarding the rotator cuff surgery. Such information may include text 84 or images 85 which are also links. By selecting one of the images 85 of interest, additional information may be provided. The information may also be in the form of an enlarged drawing or even a multimedia presentation such as streaming video, video clips 85.1 as shown in FIG. 8C, or others.

As previously noted, the above described features including the physicians directory 58, the product links 62, and the diagnostic 80 accessible through the home page 52 of FIG. 5, are provided to any visitor to the home page 52 even if the visitor is not a registered user. The physicians directory 58 increases the likelihood that the visitor will use the services of one of the listed physicians. The product links 62 provide an opportunity for economic gain to the on-line store 14 by the sale of products associated with the product links 62. Moreover, the open access to various information available through the diagnostic 80 encourages the visitor to register with the healthcare information provider system 2 to gain additional benefit and information through the electronic patient healthcare system 1 in accordance with the present invention.

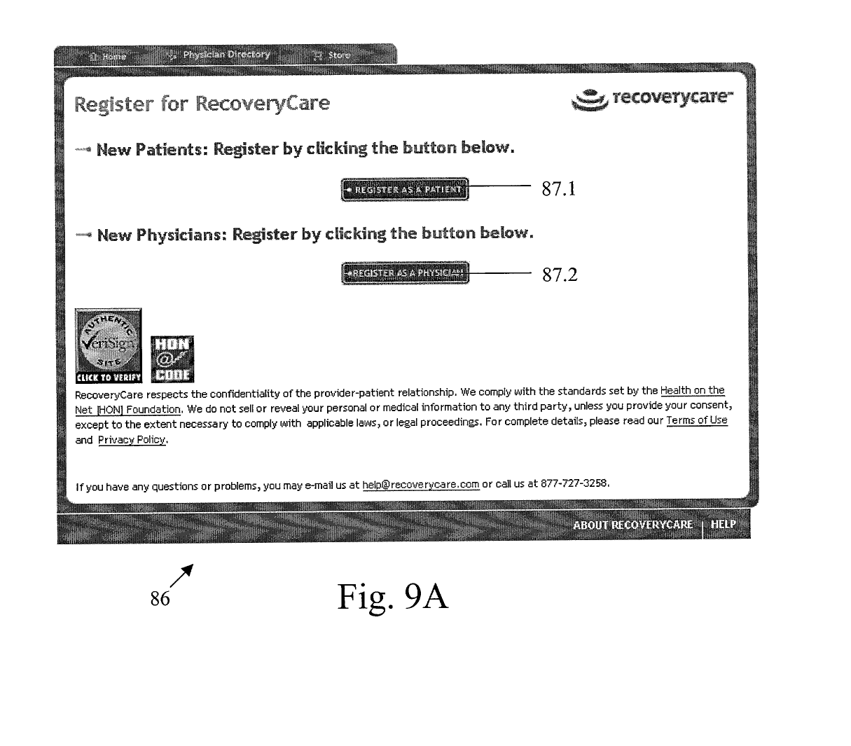

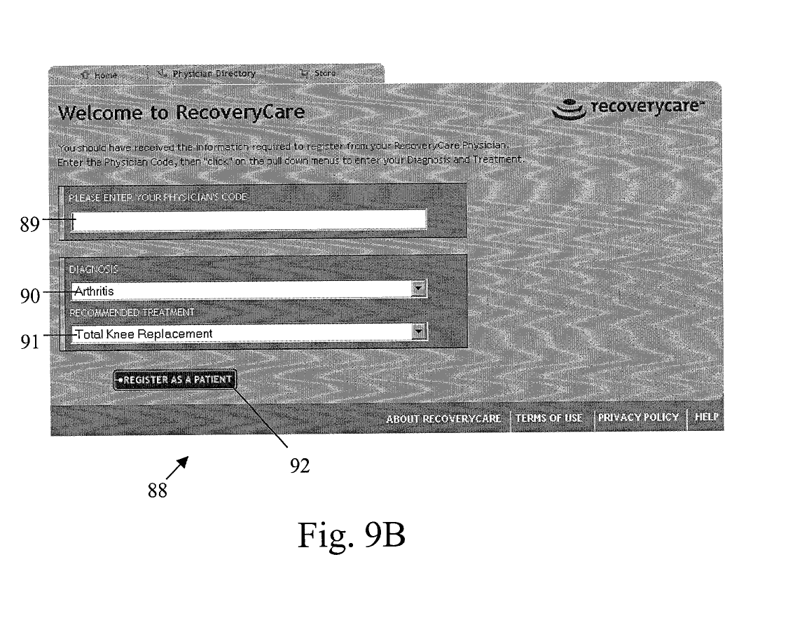

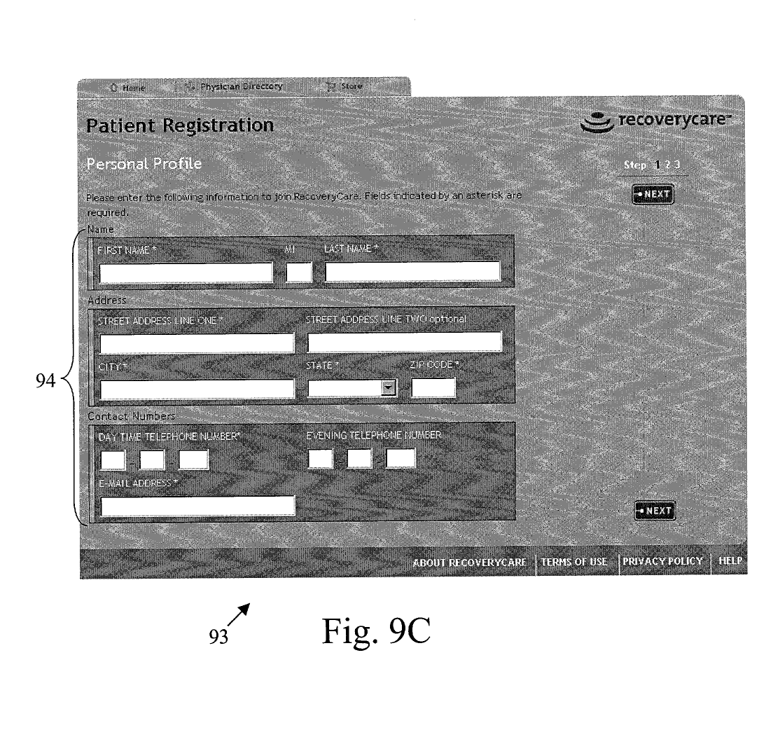

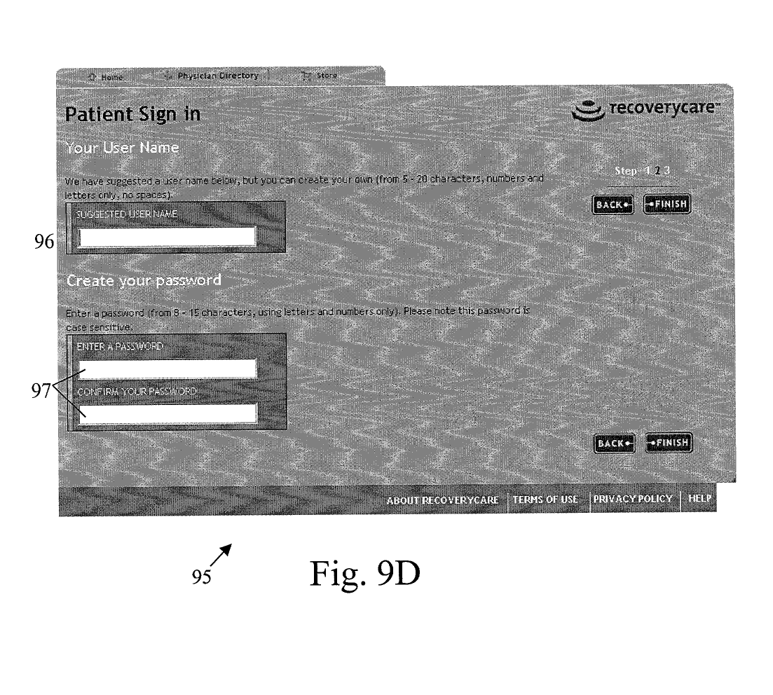

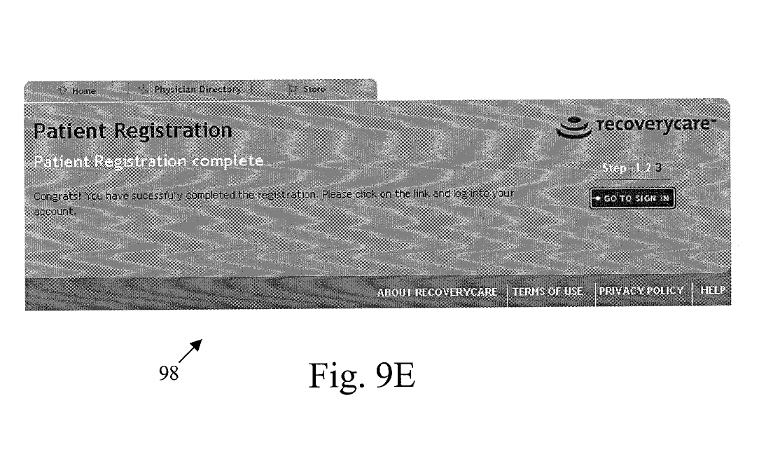

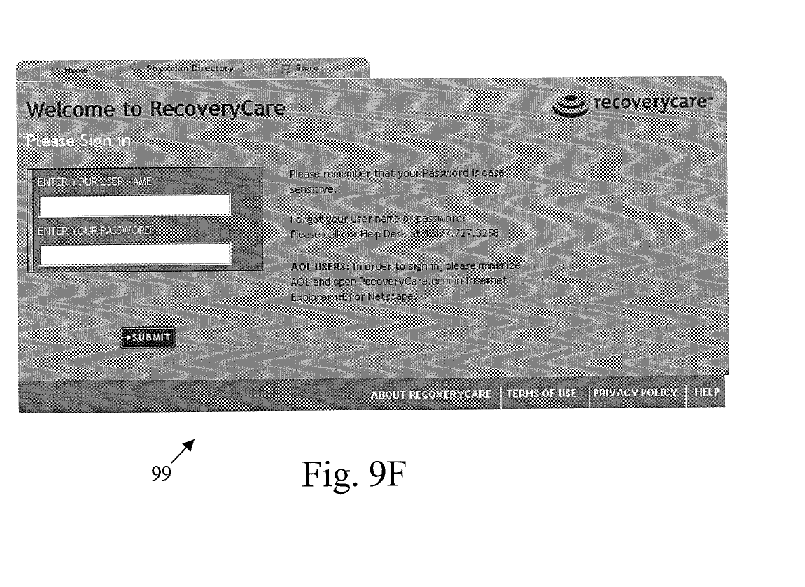

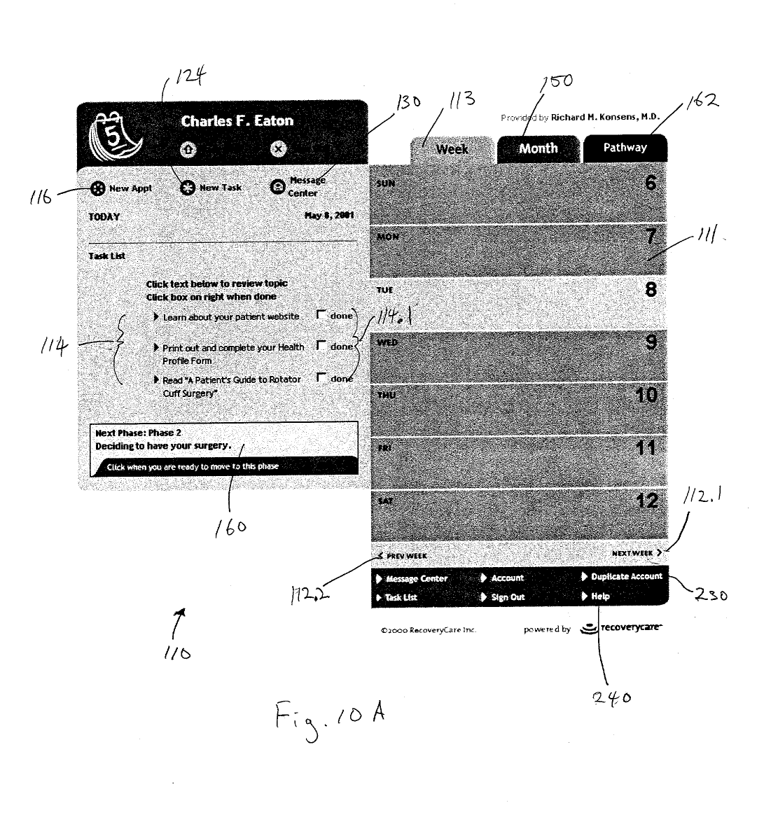

Referring again to the home page 52 of FIG. 5, new patients and physicians can register with the healthcare information provider 22 via link 56.2 which links to an identification page 86 as shown in FIG. 9A which initiates the registration of a patient via button 87.1 and of the physician via button 87.2. It is noted that the registration and the web site experience of the patient is initially discussed herein, followed by the registration and web site experience of the physician. Upon selection of button 87.1 by the patient, a corresponding registration page 88 as shown in FIG. 9B is displayed to the patient which allows the patient to begin the registration process.

In this regard, it can be seen that the patient registration page 88 includes a physician's code field 89 that, in the present embodiment, may require an entry of a code of a physician registered with the healthcare information provider system 2. This ensures that the patient is working with a physician who is familiar with the electronic patient healthcare system 1, the features of the healthcare information provider system 2, and the health information that is provided to guide the patient along a treatment pathway. Importantly, by using this code, each patient is also associated with a particular registered physician via databases 17 and 18 of FIG. 1 so as to allow electronic communication between the physician and the patient, and monitoring by the physician. For instance, the entry of the physician's code allows the patient to be associated with the physician so that appointments can be readily scheduled on-line and the physician can monitor the progress of the patient's treatment as will be discussed in context of the registered physician's web site experience.

In addition, as can also be seen in the registration page 88 of FIG. 9B, drop down menu 90 is provided for the physician's diagnosis of the patient's condition and a drop down menu 91 is provided for selection of the physician's recommended treatment for the patient. Upon initiating registration as a patient by clicking on trigger field 92, the patient is directed to the personal profile page 93 as shown in FIG. 9C. In this page, various information 94 regarding the patient is requested. In a subsequent web page 95 shown in FIG. 9D, the patient is requested for a user name in field 96 as well as a password in fields 97. Upon submission, the patient is informed of his/her registration with the healthcare information provider system 2 via web page 98 as shown in FIG. 9E and is invited to log in via sign in page 99 as shown in FIG. 9F which requires the entry of the user name and the password as created in web page 95 of FIG. 9D.

Referring again to FIG. 5, already registered patients can sign in by selecting link 56.1 which is linked to the sign-in page 99 shown in FIG. 9F discussed above. As previously noted, the registration and log in procedures for the physician is discussed in a separate discussion below after the discussion of features provided to patients registered with the healthcare information provider system 2 and using the electronic patient healthcare system I in accordance with the preferred embodiment of the present invention.

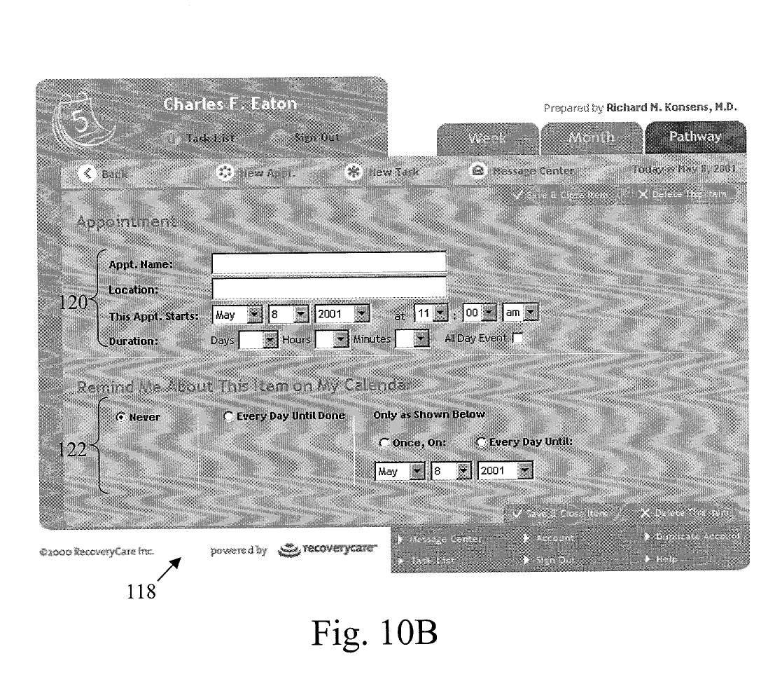

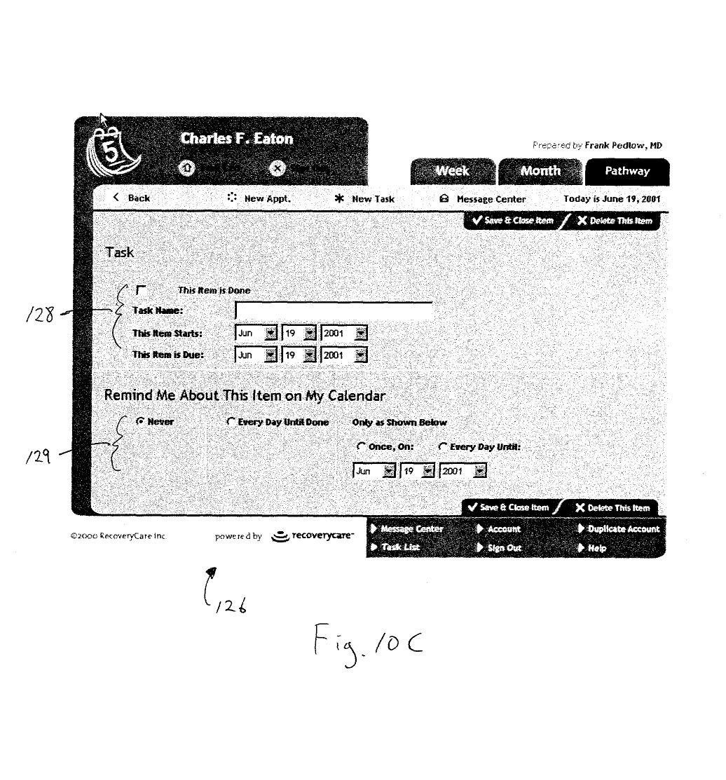

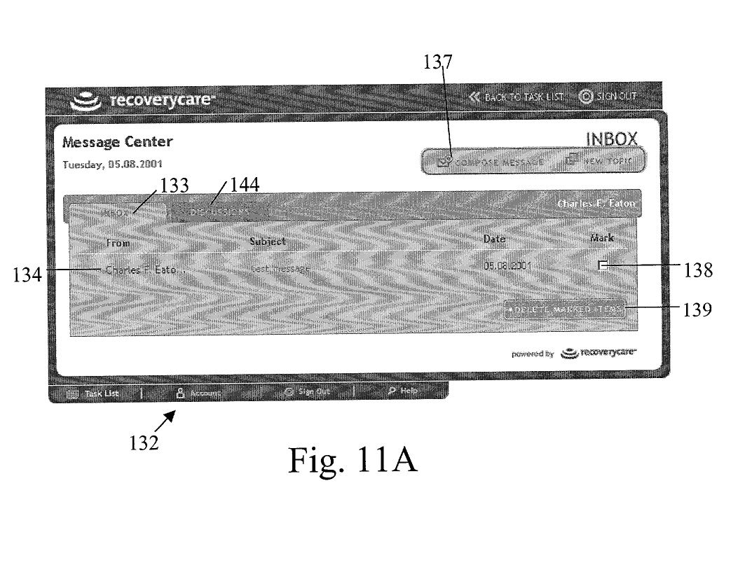

Once the registered patient has logged into the healthcare information provider system 2, which in the present embodiment is implemented in a web site 52 accessible via the Internet, the patient is presented with a personalized web page 110 as shown in FIG. 10A. The personalized web page 110 identifies the current date and provides a weekly calendar 111 associated with a week tab 113 which would display in the corresponding day any medical appointments that the patient may have in the present week (no appointments being shown in the present illustrated example). The subsequent or prior weeks of the month can be displayed by clicking on the trigger fields 112.1 and 112.2 respectively thereby allowing the patient to view past and future medical appointment entries.

The personalized web page 110 also includes a task list 114 discussed in further detail below which briefly identify the tasks to be performed by the patient in the current phase of the treatment pathway for the patient. Each of the tasks in the task list 114 are linked to one of the pre-event set 20 of electronically displayable files containing health information for preparing and educating the patient for the medical event or to one of the post-event set 22 of electronically displayable files containing health information for preparing and educating the patient for post-event recovery so as to guide the patient along the treatment pathway timeline display 32. Thus, as can be appreciated, the tasks in the task list 114 are correlated to the various task files 28 shown in FIG. 2B in the electronically displayable files 16 and instructs the patient to perform a predetermined task. Each of the tasks in the task list 114 are thus associated with a reference or educational material related to the patient's diagnosis, treatment, and/or recovery, and/or requests the completion of tasks such as scheduling an appointment, taking medication, evaluations etc., examples of these tasks having been previously discussed. When the patient has completed the required task in the task list 114, the patient interactively clicks on the boxes 114.1 labeled “done” to the right of each task which moves the task link to the bottom of the task list 114. As can be recognized, the boxes 114.1 correlate to the confirmation sub-file 29 discussed previously relative to FIG. 2B. As will be explained in further detail hereinbelow, these tasks in the task list 114 are designed and presented under time-sequenced phase images which will ensure successful education and preparation of the patient for the medical event and for successful recovery post-event.

From the personalized web page 110 of FIG. 10A, the patient can also enter new appointments to the task list 114 and calendar 111 by clicking on the new appointment button 116. The new appointment button 116 is linked to an appointment page 118 as shown in FIG. 10B. The patient can enter the appointment information in the appointment fields 120 and request reminders of the appointment on the calendar 111 of the personalized web page 110 using the reminder feature 122. In a similar manner, a new task may be entered into the task list 114 by clicking on the new task button 124 which is linked to task page 126 of FIG. 10C. As can be seen, the details 128 of the requested task to be entered into the task list 114 of the personalized web page 110 is provided by the patient and a reminder may also be requested using the reminder feature 129. It should also be noted that once the due date has passed with respect to the new appointment and/or task, the appointment and/or task is no longer displayed on the task list 114 of the personalized web page 110.

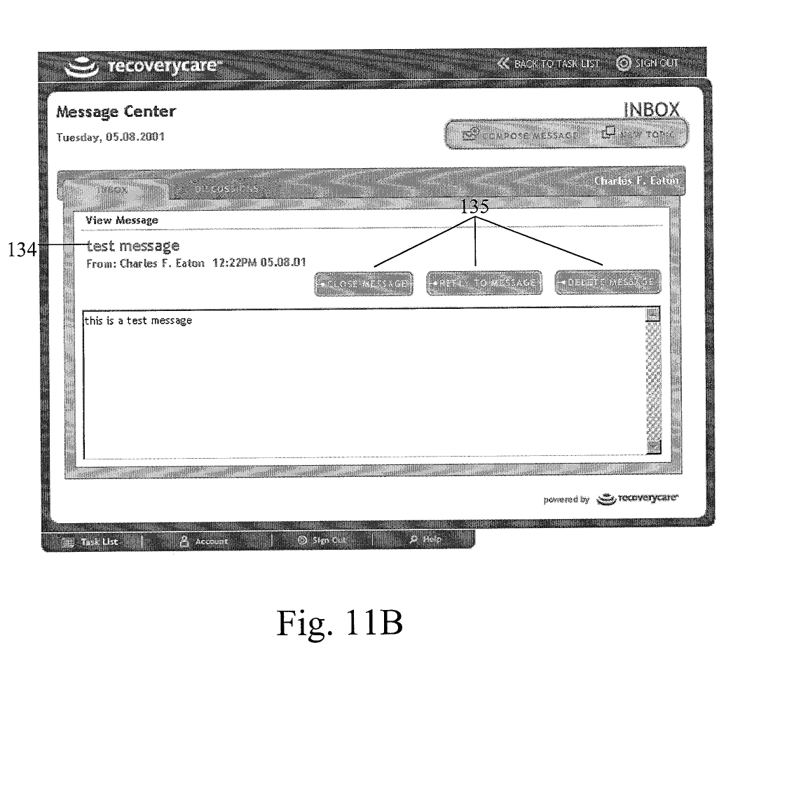

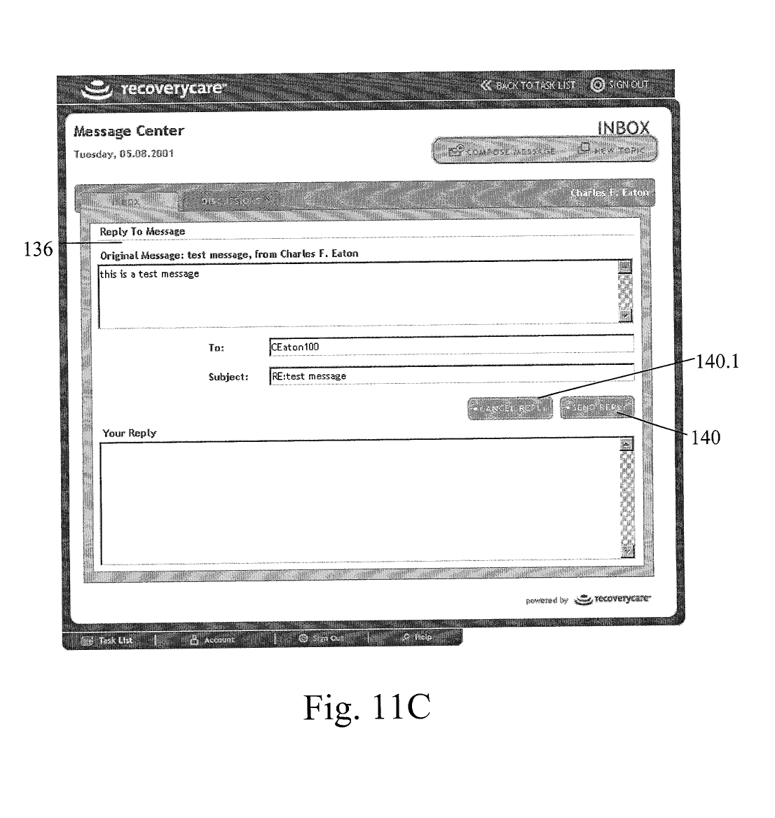

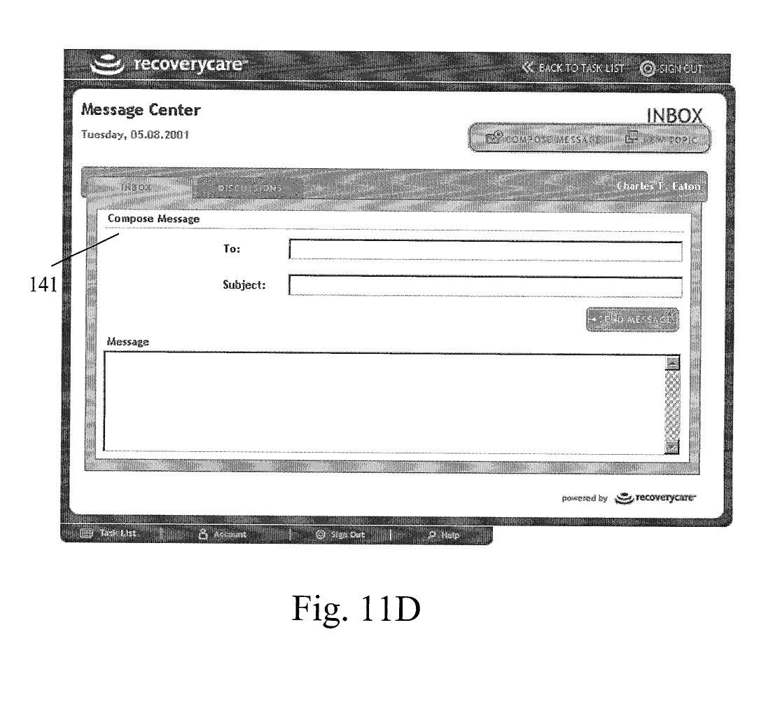

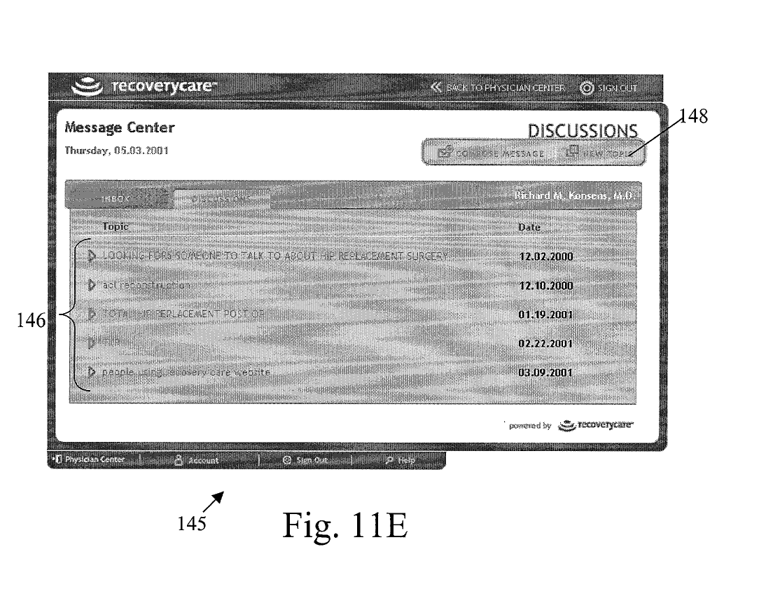

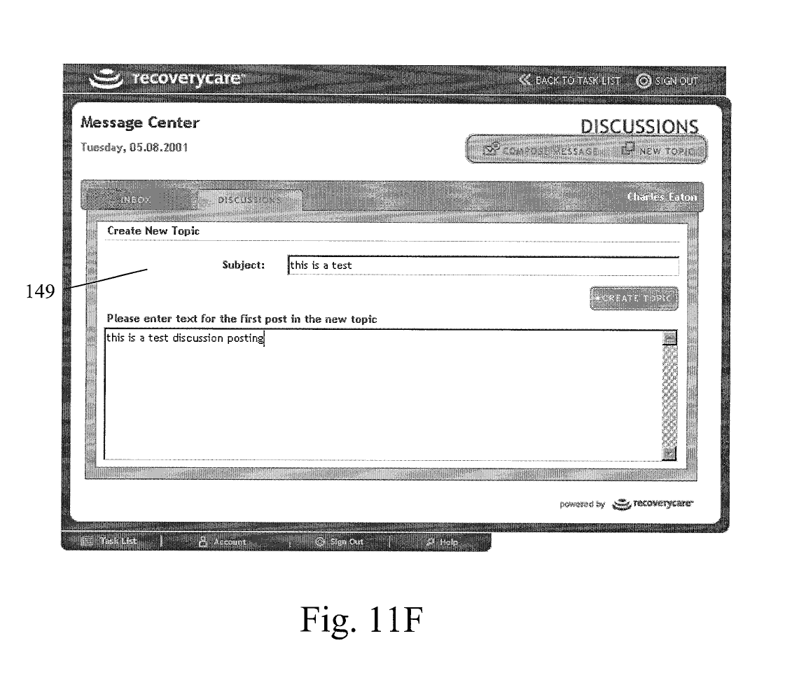

Referring again to the personalized web page 110 shown in FIG. OA, a message center button 130 may be provided which is linked to message center web page 132 as shown in FIG. 11A. As can be seen, the message center web page 132 includes an inbox 133 which lists e-mail messages such as message 134 which can be viewed by opening it as shown in FIG. 11B. Upon viewing the message 134, the message can be closed, replied to, or deleted as shown by the various function buttons 135. For instance, FIG. 11C illustrates a reply 136 to the message 134, the reply being initiated by selecting the “reply to message” function button 135. After the reply to the message 136 is composed, the reply can be sent by selecting the “send reply” button 140, or be canceled by selecting the “cancel reply” button 140.1. Moreover, referring again to FIG. 11A, a new message may be composed by selecting the “composed message” button 137. When the “composed message” button 137 is selected, a new message 141 is displayed to the patient as shown in FIG. 11D so that a message can be drafted. As can also be seen in the message center web page 132 of FIG. 11A, the message 134 can be deleted by clicking on the box 138 and selecting the “delete marked items” button 139.

Lastly, as shown in FIG. 11A, the message center web page 132 also includes a discussions forum which can be accessed by selecting the “discussions” tab 144 which is linked to a discussions web page 145 as shown in FIG. 11E, the discussions web page 145 providing a topic list 146 showing the recent topics discussed in the discussions forum. By selecting one of the listed topics of the topic list 146, the discussion associated with that topic is displayed to the patient. Moreover, by selecting the “new topic” button 148, a new topic post 149 is provided as shown in FIG. 11F which allows the patient to post a discussion on a new topic.

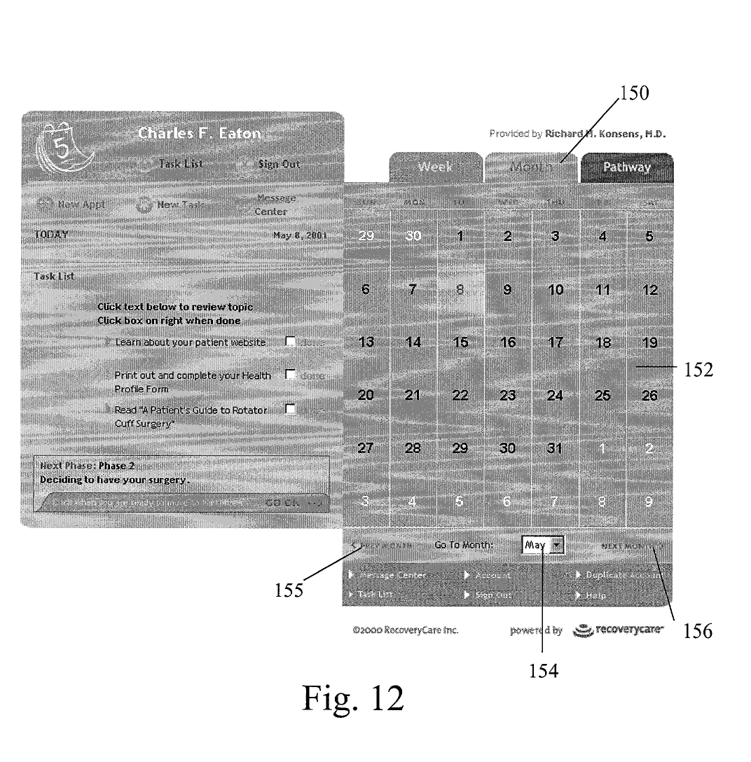

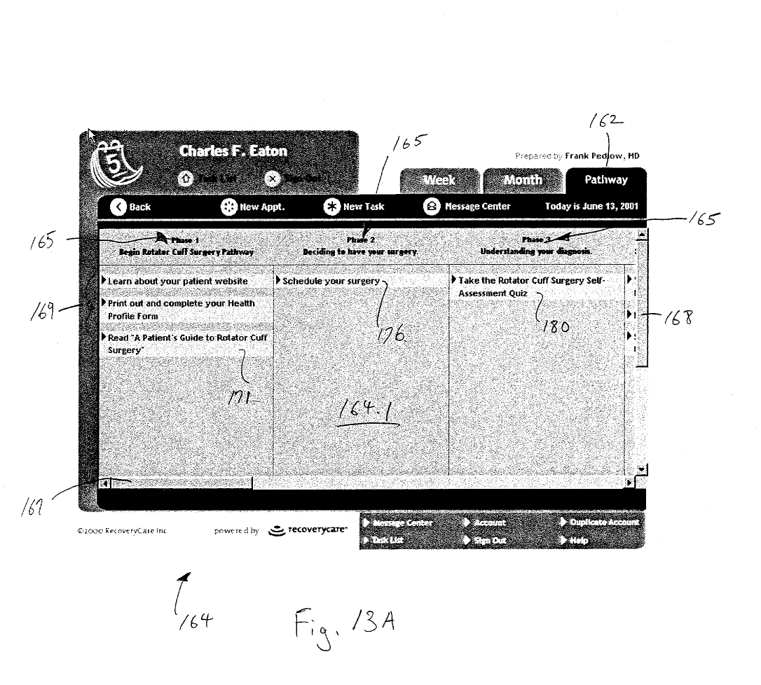

Referring again to the personalized web page 110 of FIG. 10A, the patient may display a monthly calendar by selecting tab 150 which provides a monthly calendar 152 as shown in FIG. 12. As can be seen in FIG. 12, a patient may skip to a particular month using the drop down menu 154, call up the previous month by selecting the trigger field 155, or call up the subsequent month by selecting trigger field 156.

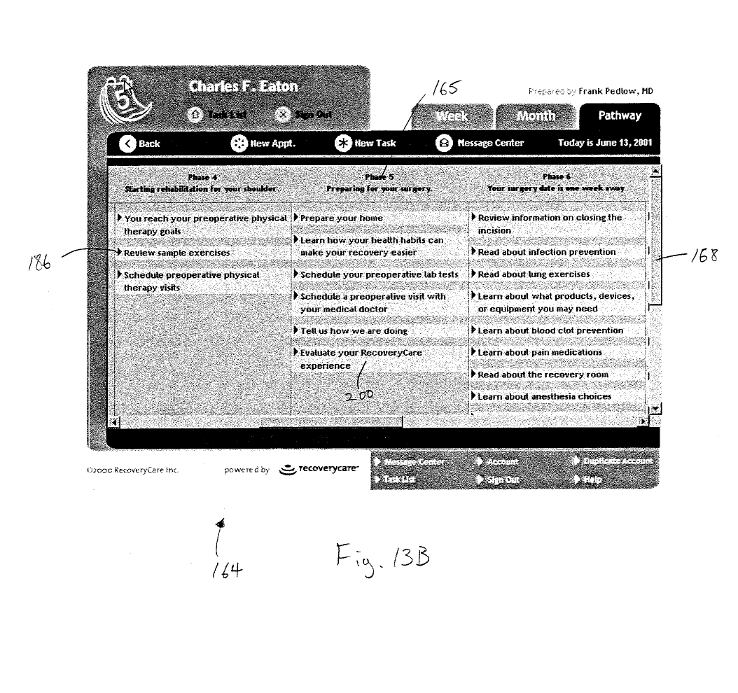

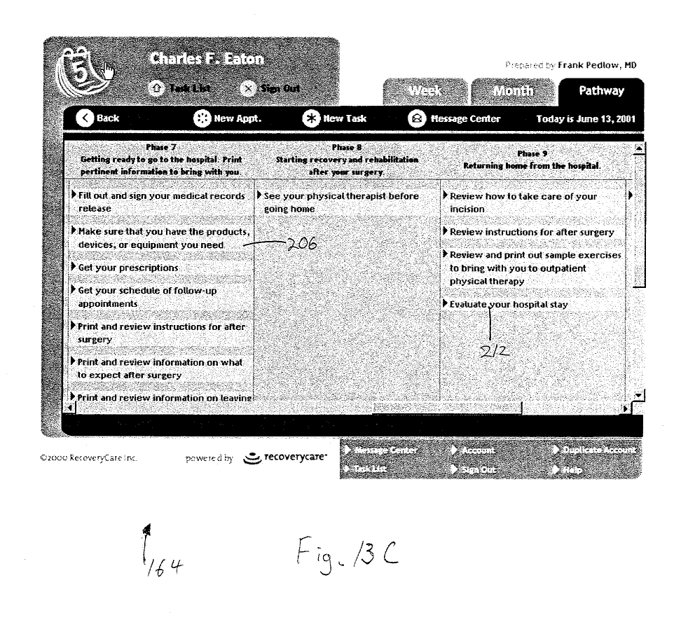

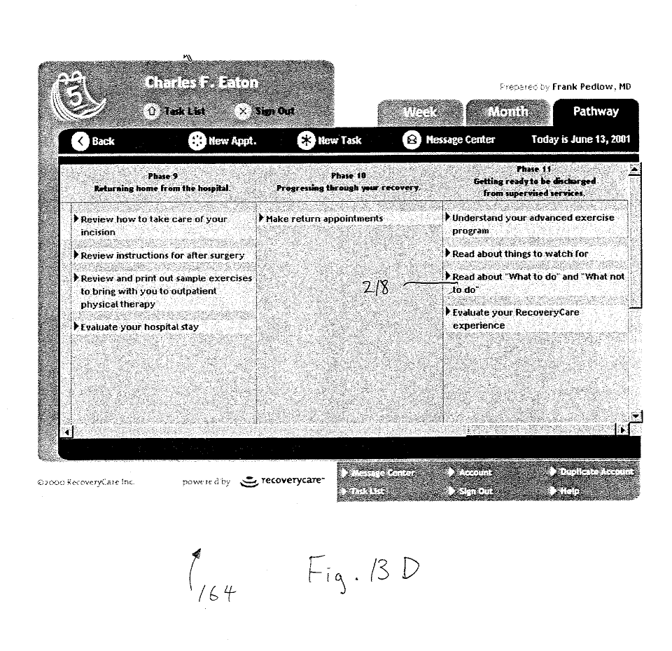

As can also be seen in FIG. 10A, the personalized web page 110 further identifies a patient's next phase of the treatment pathway in phase box 160. In other words, the phase box 160 identifies the subsequent phase in the patient's treatment along a treatment pathway which was discussed above and is discussed in further detail hereinbelow. In this regard, the patient can access his/her treatment pathway timeline display 164.1 by selecting tab 162 which is linked to pathway page 164 as shown in FIG. 13A. As can be seen, the pathway page 164 displays a treatment pathway timeline display 164.1 including a plurality of phase images 165 that define a treatment pathway related to the diagnosis and treatment of the patient. The plurality of phase images 165 correspond to the time-sequenced phase images 34 of the treatment pathway timeline display 32 shown in FIG. 3 discussed above. The treatment pathway guides the patient through the relevant medical event by educating and preparing the patient for the medical event and post-event recovery in a sequenced order as described previously thereby setting forth, step-by-step, the requisite tasks that should be completed by the patient in order to successfully complete the recommended treatment.

For instance, in the illustrated embodiment of FIG. 13A, patient named Charles F. Eaton has logged into the healthcare information provider system 2 in accordance with the present invention and has indicated that the recommended treatment as provided by his physician is for a rotator cuff surgery. Consequently, the pathway page 164 displays a treatment pathway timeline display 164.1 that corresponds to such treatment, namely rotator cuff surgery as shown under the header “phase 1”. As can be also seen, the pathway page 164 indicates subsequent phase images 165 including phase 2 entitled “deciding to have your surgery” and phase 3 entitled “understanding your diagnosis”, which again, correspond to the time-sequenced phase images 34 described previously. As can also be appreciated, the pathway page includes scroll bars 167 and 168. Using the horizontal scroll bar 167, the remaining phase images 165 of the treatment pathway timeline display 164.1 can also be viewed by the patient as shown in FIGS. 13B-13D. In particular, in the present illustrated example, FIG. 13A shows phase images 1-3 of the treatment pathway timeline display 164.1, while FIG. 13B shows phase images 4-6, FIG. 13C shows phase images 7-9, and FIG. 13D shows phase 9 again as well as phase 10 and 11.

As can be seen by the examination of FIGS. 13A-13D, the treatment pathway timeline display 164.1 as shown in the pathway page 164 guides the patient through the medical event which in this case, is rotator cuff surgery, by educating and preparing the patient for the surgery and post surgery recovery. As can be seen by the descriptions regarding the respective phase images 165, the treatment pathway timeline display 164.1 sets forth a sequenced order of phase images 165 beginning from the initial understanding of the rotator cuff surgery, and including understanding the patient's diagnosis (phase 3), preparing for the surgery (phase 5), starting recovery and rehabilitation after the surgery (phase 8), and even up to being discharged from supervised services (phase 11).

In addition, as also can be seen in FIGS. 13A-13D, each of the phase images 165 include one or more tasks that should be completed by the patient prior to proceeding to the next subsequent phase. For instance, in phase 1, the patient is instructed in the task list 169 to learn about the patient web site, print out and complete a health profile form, and to read a document entitled “A Patient's Guide to Rotator Cuff Surgery”. It should now be observed that this task list 169 as shown in FIG. 13A corresponds to the task list 114 of the personalized web page 110 as shown in FIG. 10A. Each of these tasks under each of these phase images 165 of the treatment pathway timeline display 164.1, are specifically designed to guide the patient successfully through each of the phases by educating and preparing the patient for the rotator cuff surgery and post-event recovery. As can be seen in FIG. 13B, phase 6 includes numerous tasks that are included on pathway page 16 but that, in the illustrated embodiment and due to the volume of information, are not displayed on the patient's screen at the same time. However, by using the vertical scroll bar 168, the patient can view the remaining tasks in phase 6.

Again noting that the task list 114 of FIG. 10A corresponds to the task list 169 of phase 1 as shown in the pathway page 164 of FIG. 13A, it should now be evident the patient Charles F. Eaton was in phase 1 of the treatment pathway timeline display 164.1 and thus, the personalized web page 110 displayed the task list 114 which corresponds to the task list 169 of phase 1 as shown in the pathway page 164. As the patient completes each of the tasks 114 as shown in the personalized web page 110 and indicates their completion by interactively clicking the “done” boxes 114.1 associated with each of the tasks, the personalized web page 110 is correspondingly updated so that the task list 114 displays the tasks of the subsequent phase. In this case, task list 114 of phase 2 is displayed, which is to schedule the rotator cuff surgery in the present example, as can be seen in the pathway page 164 of FIG. 13A.

It should also be noted that each of the task lists 169 under each of the phase images 165 shown in the treatment pathway timeline display 164.1 are also linked to one of the pre-event set 20 of electronically displayable files containing health information for preparing and educating the patient for the medical event or to one of the post-event set 22 of electronically displayable files containing health information for preparing and educating the patient for post-event recovery so as to guide the patient along the treatment pathway timeline display 32 as discussed relative to FIGS. 2A and 2B. Thus, the tasks in the task list 169 are correlated to the various task files 28 shown in FIG. 2B in the electronically displayable files 16 and instructs the patient to perform a predetermined task as discussed previously. In particular, such tasks may include viewing a document file, printing out and completing a form, taking a quiz, scheduling an appointment, viewing pictures and/or other multimedia presentations, taking medication, purchasing medical products, completing an evaluation form, etc.

In accordance with the preferred embodiment of the present invention, these tasks are provided in a plurality of sequenced phases that correlate to the patient's phase of treatment in the treatment pathway so as to minimize confusion, frustration, and unpreparedness which can occur if the patient is not provided with sufficient information, or too much information, or information which are not sequenced in the proper order of the patient's experience. By providing a treatment pathway with a series of time-sequenced phase images, each phase providing a list of tasks that the patient should complete in a step-by-step manner, the likelihood of effective treatment of the patient is greatly enhanced by the present invention. In this manner, the electronic patient healthcare system 1 in accordance with the present invention guides the patient through the medical event, in this case, a rotator cuff surgery, by educating and preparing the patient for the medical event and post-event recovery in a timely, sequenced, organized and structured manner.

Referring again to FIGS. 13A-13D, the various tasks to be performed by the patient in the task lists 169 of each of the phase images 165 are links to tasks to be completed by the patient as previously described. Several specific examples of tasks selected from the tasks lists 169 of the phase images 165 are discussed below in detail to illustrate various features and functions of the present invention. Whereas in the discussions below, each of the tasks are initiated through the treatment pathway timeline display 164.1 shown in FIGS. 13A-13D, it is again noted that each of the task lists 169 are displayed as task list 114 in the personalized web page 110 of FIG. 10A and the tasks can be completed via the personalized web page 110. Thus, in the below described examples of the present invention, the patient actually has two options for selecting and completing the tasks of each phase of the treatment pathway. The patient can wait until the task is displayed on the task list 114 of the personalized web page 110 as shown in FIG. 10A, or in the alternative, can view the treatment pathway timeline display 164.1 on the pathway page 164 as shown in FIGS. 13A-13D and select the appropriate link corresponding to the task of a particular phase.

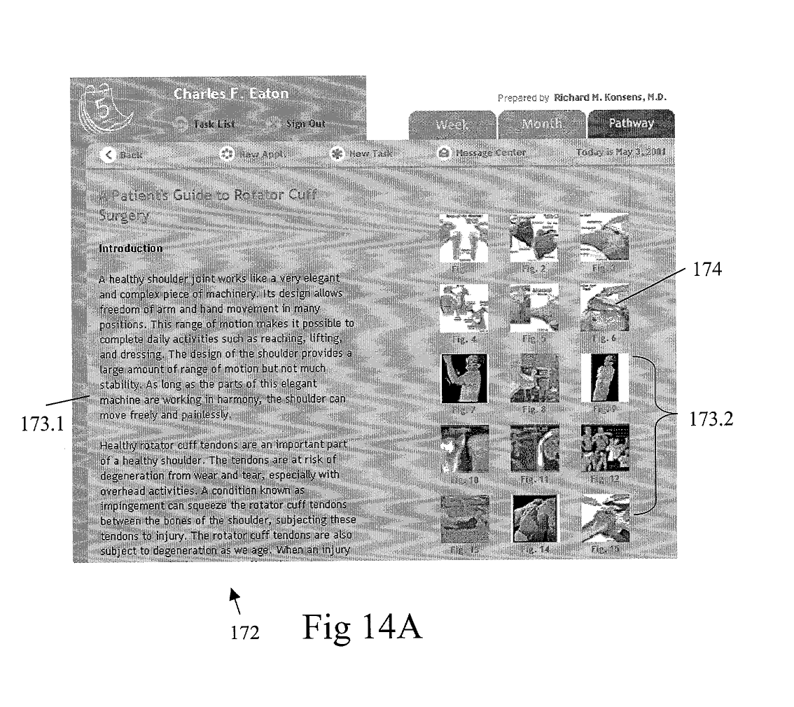

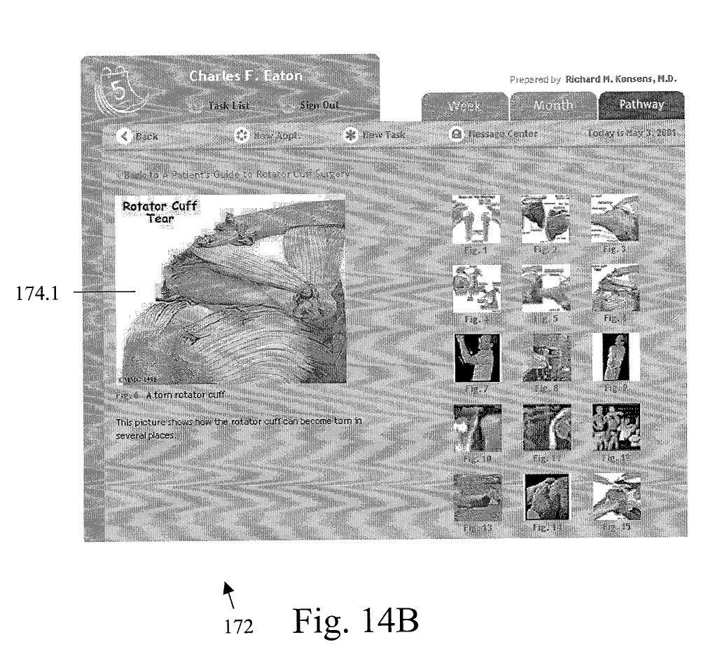

For instance, if the patient selects a specific task in a given phase such as link 171 indicated as “read ‘A Patient's Guide to Rotator Cuff Surgery’” in phase 1, an informational web page 172 as shown in FIG. 14A is displayed for the patient. As can be seen, the informational web page 172 merely corresponds to the informational web page 83 of FIG. 8B and likewise, includes various text 173.1 and images as previously described. By selecting one of the images such as image 174, an enlarged image 174.1 as shown in FIG. 14B is displayed to the patient that corresponds to the selected image. Of course, these images may also be multimedia presentations such as video clips with audio playback as discussed previously.

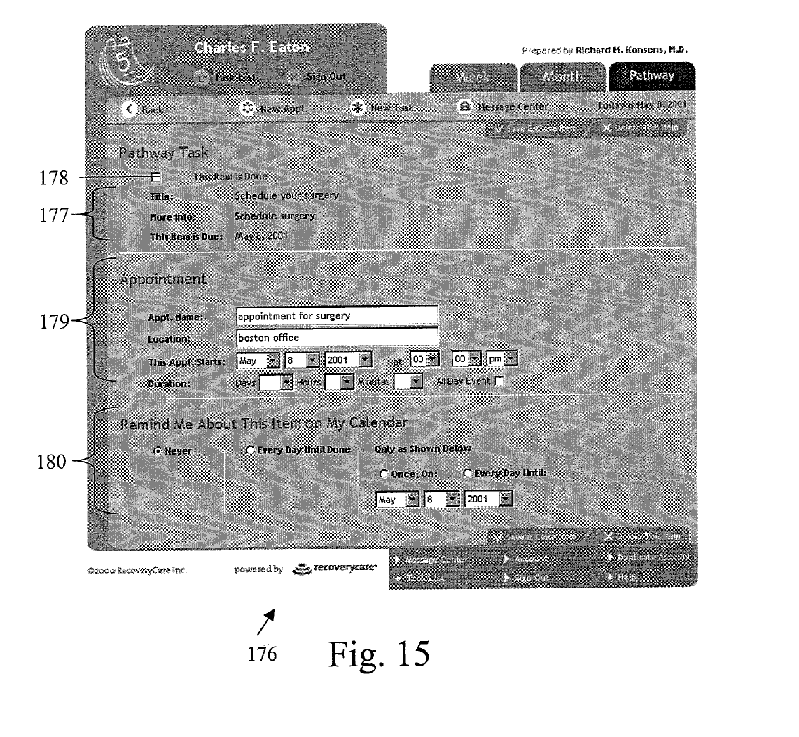

Referring again to the pathway page 164 of FIG. 13A, if the patient selects the link 176 indicated as “schedule your surgery”, an appointment page 176 as shown in FIG. 15 is displayed for the patient. As will be recognized, the appointment page 176 is similar to the appointment page 118 as described above relative to FIG. 10B except that appointment page 176 also includes pathway task information 177 as well as a box 178 which can be clicked by the patient to indicate completion of the specific identified task, in this example, the scheduling of the surgery. As previously described relative to the appointment page 118 of FIG. 10B, the appointment page 176 of FIG. 15A also correspondingly allows the scheduling of the appointment via appointment fields 179 which automatically inserts the appointment and the specified time of the appointment into the patient's calendar 111 displayed on the personalized web page 110 as described previously relative to FIG. 10A. In addition, the appointment page 176 also includes the reminder feature 180 for reminding the patient about the upcoming appointment. Of course, in another embodiment of the present invention, the appointment may be made using the e-mail features provided through the message center described previously relative to FIGS. 11A-11F. Moreover, it should again be noted that whereas in the present discussed embodiment, the patient has chosen to call up the schedule of his/her surgery by selecting the link 176 of phase 2 in the pathway page 164 as shown in FIG. 13A, upon completing all the tasks of the task list 114 shown on the personalized web page 110 of FIG. 10A, the task of scheduling his/her surgery would automatically be displayed in the task list 114. Upon selecting the link in the task list 114, the appointment page 176 of FIG. 15 as previously described would then be displayed to the patient so that appointment can be made and added to the patient's calendar 111.

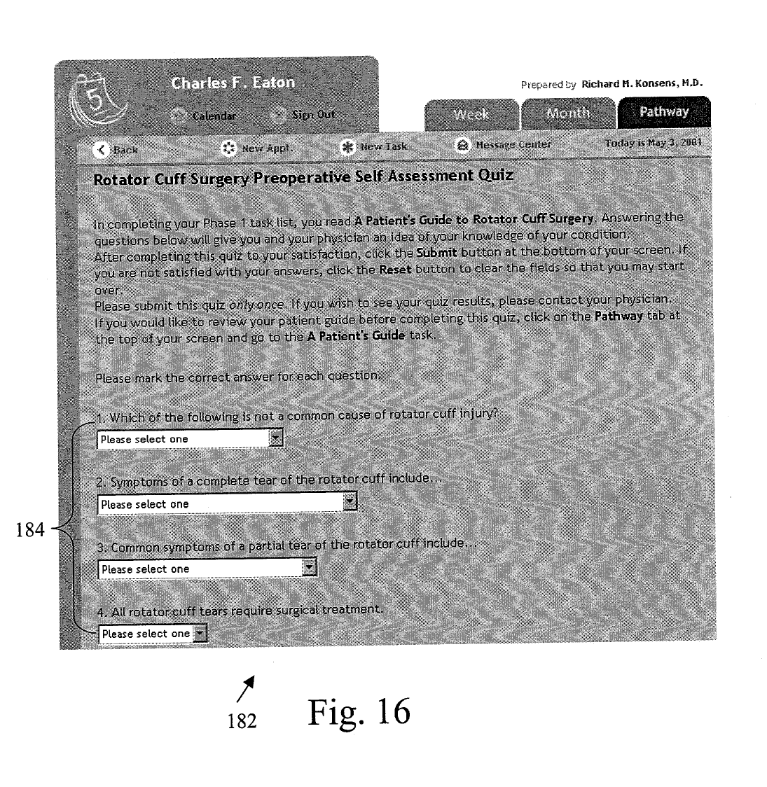

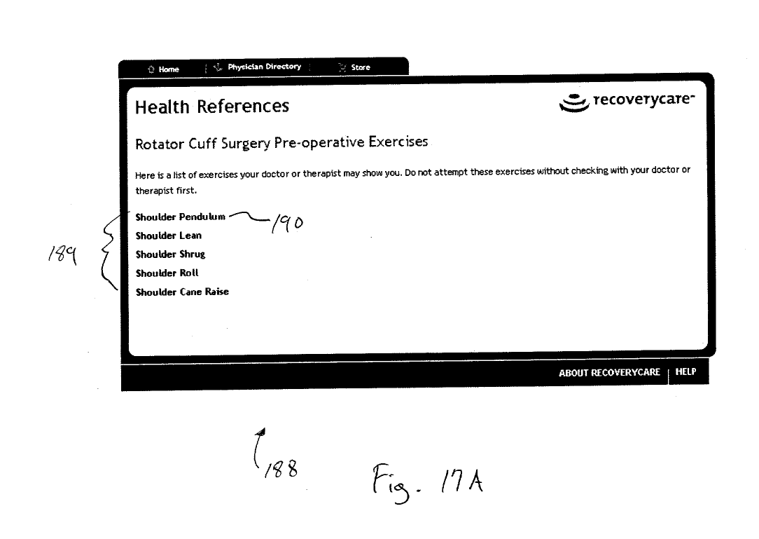

Referring again to the pathway page 164 of FIG. 13A, if the patient selects link 180 identified as “take the rotator cuff surgery self-assessment quiz” in phase 3 of the treatment pathway timeline display 164.1, a self-assessment quiz page 182 as shown in FIG. 16 is displayed to the patient to quiz his/her understanding of the rotator cuff surgery which he/she is scheduled to undergo. In this regard, the self-assessment quiz page 182 may be provided with a plurality of questions 184 which tests the knowledge and understanding of the patient regarding the particular medical event. As can be seen, in the present and illustrated embodiment, the questions are provided in a drop down menu in a multiple-choice format. Moreover, whereas only four questions are shown in the illustrated embodiment of FIG. 16, many more questions can be provided in the self-assessment quiz page 182. It should be evident that the quiz may be provided in many other formats as well in other embodiments By providing such a quiz as a task in a phase of the treatment pathway, the physician can determine the extent of the patient's knowledge of the medical event, in this case rotator cuff surgery, in the manner described in further detail herein below.

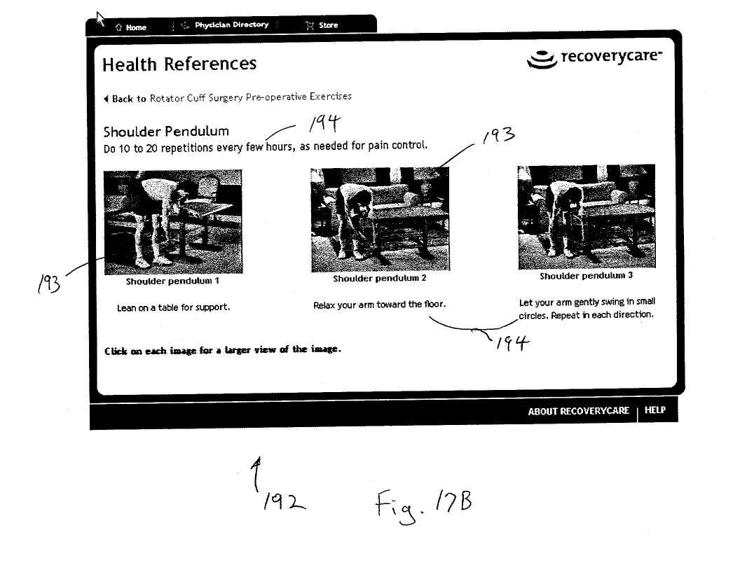

As part of the treatment pathway, the patient may also be requested to study preoperative exercises. For instance, upon selection of link 186 identified as “review sample exercises” of phase 4, an exercise list page 188 as shown in FIG. 17A is displayed for the patient. The exercise list page 188 is tailored to provide a listing 189 of various preoperative exercises that are related to the medical event and the treatment pathway of the patient, in this case, rotator cuff surgery. Each of the exercises identified in the listing 189 is a link to an exercise page. For instance, if the link 190 identified as “shoulder pendulum” is selected by the patient, an exercise page 192 of FIG. 17B is displayed to the patient that explains the shoulder pendulum exercise. As can be seen, the exercise page 192 includes images 193 and textural information 194 which explains both the exercise and the repetition for the exercise. Of course, FIG. 17B only illustrates one exercise, namely the shoulder pendulum exercise, and other such exercise pages may be provided for each of the exercises in the listing 189 of the exercise list page 188 of FIG. 17A.

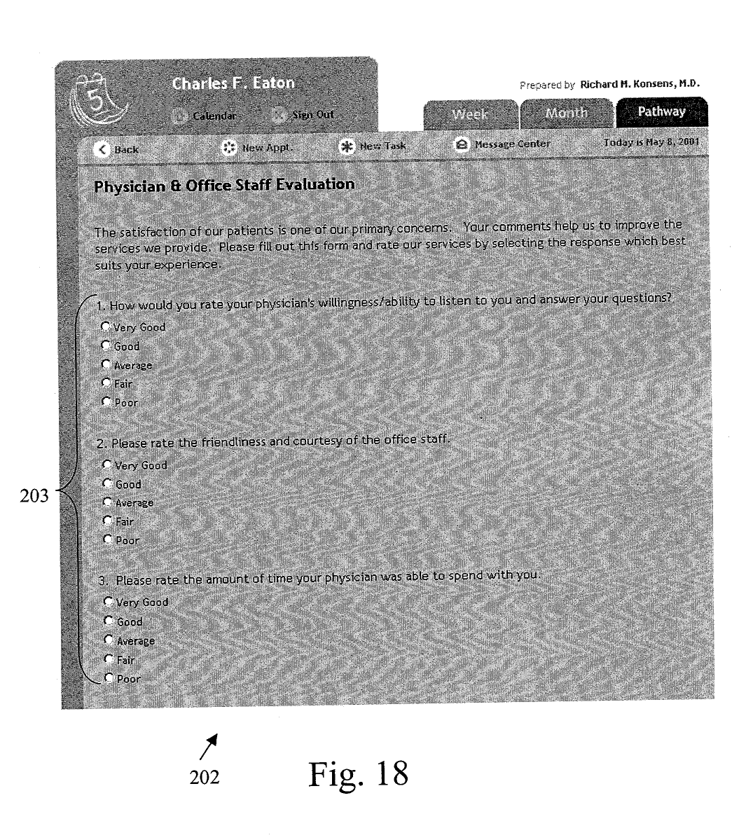

In accordance with one embodiment of the present invention, the treatment pathway timeline display 164.1 for the patient as shown in the pathway page 164 of FIG. 13B can be used to obtain information regarding perceived quality of the services provided and the satisfaction level of the patient. For instance, during phase 5 of the treatment pathway, the patient can evaluate his/her experience by selecting link 200 indicated as “evaluate your recovery care experience”. Upon selection of link 200, evaluation web page 202 as shown in FIG. 18 is displayed to the patient. As can be seen, the evaluation web page 202 includes a plurality of questions 203 to which the patient can respond which rates the services of the physician and office staff. As will be explained hereinbelow, the patient's responses can be accessed by the physician treating the patient so as to allow determination of the patient's satisfaction and the quality of the services rendered by the physician. Of course, it is again noted that this task will be automatically displayed in the task list 114 of the personalized web page 110 and need not be initiated via the treatment pathway timeline display 164.1.

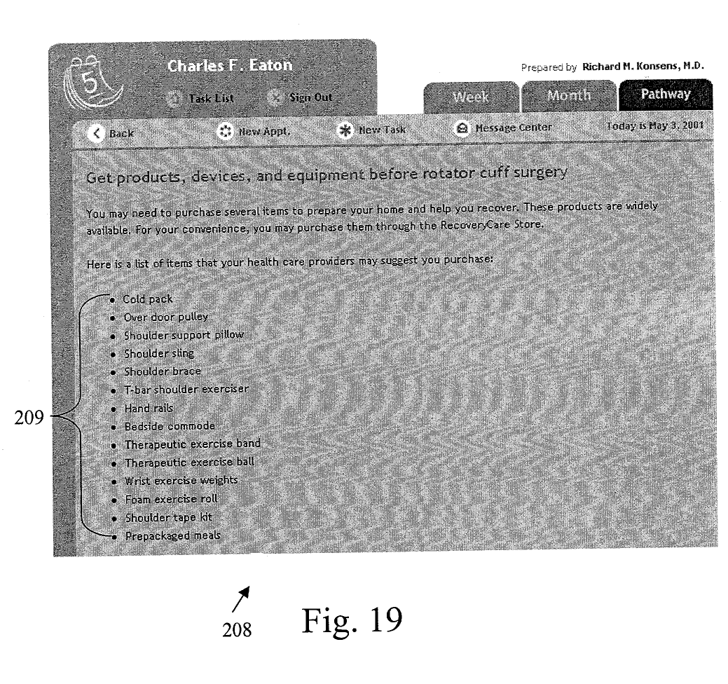

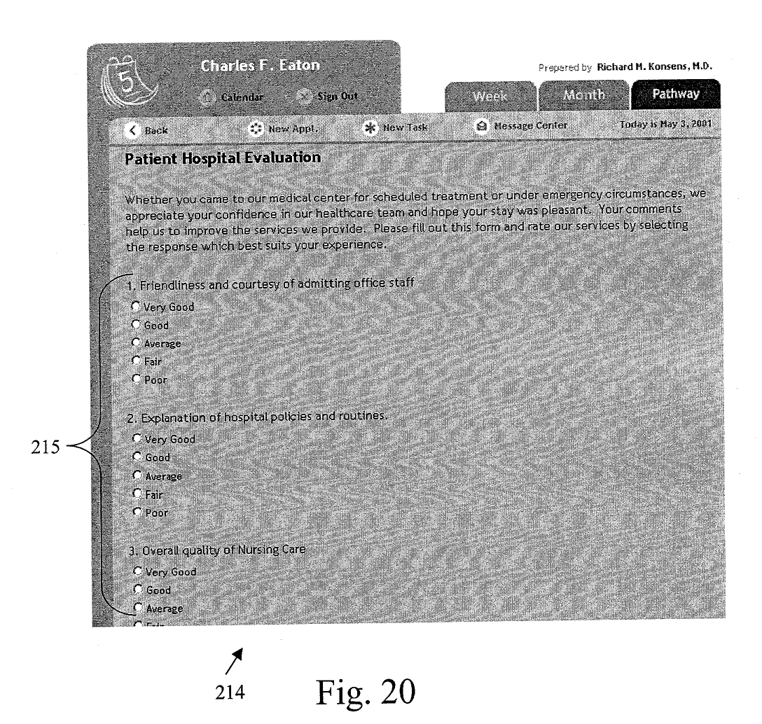

Now referring to the pathway page 164 as shown in FIG. 13C, the treatment pathway in accordance with one embodiment of the present invention may be used to remind patients to acquire or purchase various products likely to be needed before, during, or after the medical event. For instance, as can be seen in FIG. 13C, a task may be provided in phase 7 of the treatment pathway as indicated by link 206 in which once selected by the patient, an equipment list page 208 as shown in FIG. 19 is displayed. As can be seen, the equipment list page lists various products, devices, and equipment in list 209 that will likely be required for the particular medical event, i.e. rotator cuff surgery. By providing such a equipment list in a timely manner before the surgery, the patient is given sufficient time to acquire the required equipment and the stress of identifying and purchasing the equipment at the last minute before the surgery is avoided thereby reducing the stress experienced by the patient as the surgery approaches. In this regard, a link (not shown) may be provided to an on-line store where such products can be purchased by the patient on-line to further facilitate preparation for the medical event, such a store having been discussed above relative to FIG. 1. Again, it is noted that this task will be automatically displayed in the task list 114 of the personalized web page 110 and need not be initiated via the treatment pathway timeline display 164.1.

Referring again to the pathway page 164 as shown in FIG. 13C, the treatment pathway in accordance with one embodiment of the present invention can also be used to evaluate the patient's hospital experience. In this regard, phase 9 of the treatment pathway timeline display 164.1 may include a task which requests the evaluation of the patient's hospital stay via link 212 identified as “evaluate your hospital stay”. Upon selection by the patient, hospital evaluation page 214 as shown in FIG. 20 is displayed. In a manner similar to that of the evaluation web page 202 of FIG. 18, the hospital evaluation page 214 includes a plurality of parameters 215 for evaluating the patient's experience at the hospital. The patient's responses can be viewed by the physician to further enhance the quality of services provided by the hospital to future patients.

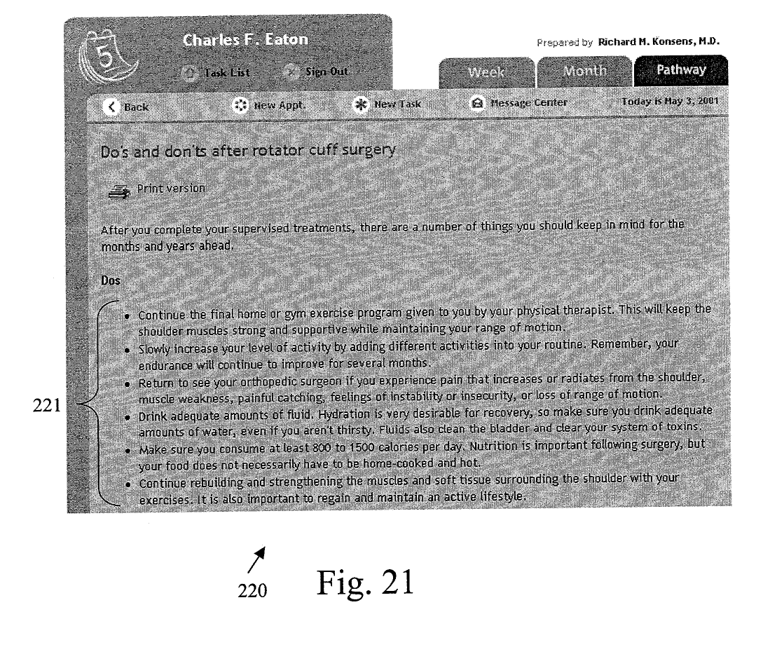

In the last example of various tasks, the pathway page 164 as shown in FIG. 13D may be provided with a link 218 in phase 11 of the treatment pathway timeline display which further instructs the patient regarding the post-event recovery. When link 218 is selected by the patient, the patient is provided with a dos and don'ts page 220 as shown in FIG. 21 that is specifically tailored to advise the patient regarding what actions to perform and what actions to refrain from after the specific medical event, in this case, rotator cuff surgery. It should be noted that in FIG. 21, only the dos portion 221 is illustrated. By providing such a page, the present invention increases the likelihood of a successful recovery of the patient after the medical event. In this regard, it should also be noted that in other embodiments of the present invention, additional tasks may be provided that are more directly related to recovery. For instance, scheduling of a follow-up appointment with the physician may be one of the tasks.

It should be noted that the above discussed tasks and their associated web pages accessible by links is merely provided as some examples of the types of tasks that can be requested from the patient using the treatment pathway in accordance with one embodiment of the present invention. Of course, as can be seen in FIGS. 13A-13D, many other tasks can be provided in the task list of each of the phase images of the treatment pathway. Thus, it should be appreciated that many different types of tasks may be provided in the various phases of the treatment pathway and the present invention should not be limited to the specific examples provided above. As previously noted, these tasks can include taking of medication, scheduling of appointments, scheduling of rides to and from the hospital, reading documents, viewing multimedia files, completing forms and surveys, evaluations, or any other appropriate task that is related to guiding the patient along the treatment pathway by educating and preparing the patient for the medical event and post-event recovery.

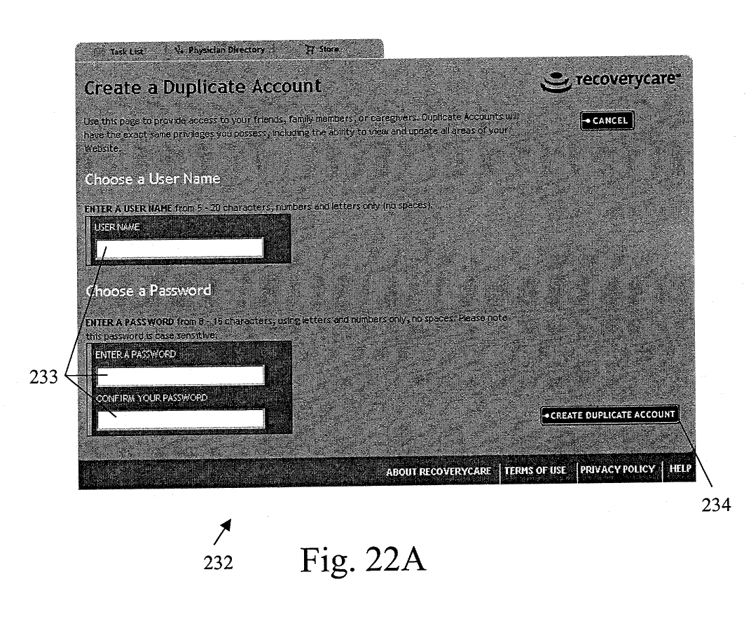

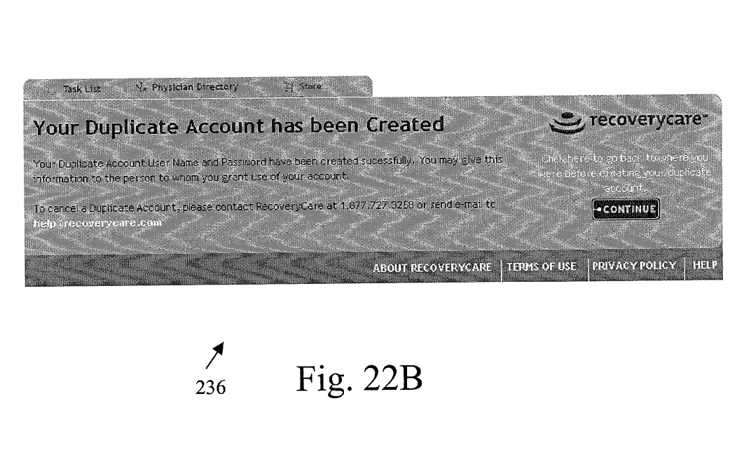

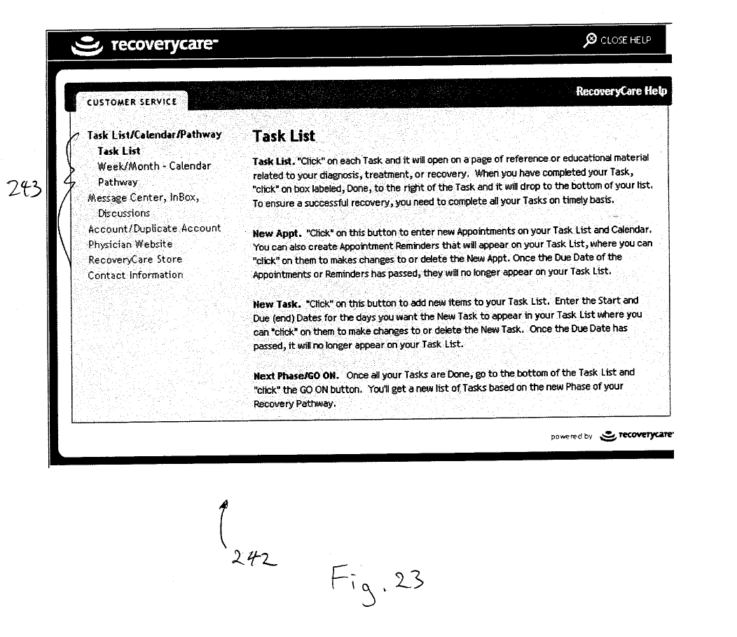

Referring again to the personalized web page 110 of FIG. 10A, the preferred embodiment of the present invention may also be provided with a duplicate account feature which may be initiated by selecting link 230 identified as “duplicate account” on the personalized web page 110. Once the link 230 is selected by the patient, create duplicate account page 232 as shown in FIG. 22A is displayed to the patient. Upon entry of a user name and password in the data fields 233, and authorized by clicking on the button 234, a duplicate account may be created which allows friends, family members, physician, or other authorized third parties to access the patient's account and information contained therein such as the patient's treatment pathway timeline display and calendar as described previously. Once such duplicate account has been created, a confirmation page 236 may be displayed to the patient as shown in FIG. 22B.

Again referring to the personalized web page 110 of FIG. 10A, the preferred embodiment of the present invention may also be provided with a help feature which may be accessed via link 240 indicated as “help”. Upon selection, a help page 242 as shown in FIG. 23 may be displayed, the help page 242 listing various topics 243 for which on-line help regarding the above described website is available, in this example, www.recoverycare.com.

Whereas in the above discussions, focus and emphasis has been directed to the web pages associated with the patient such as the treatment pathway, the discussion hereinbelow focuses on the web pages associated with healthcare practitioners utilizing the present invention. Again, it is noted that whereas the presently described web pages refer to a physician, the present invention is not limited thereto but can be used by other healthcare practitioners including nurses, therapists, etc. as well.

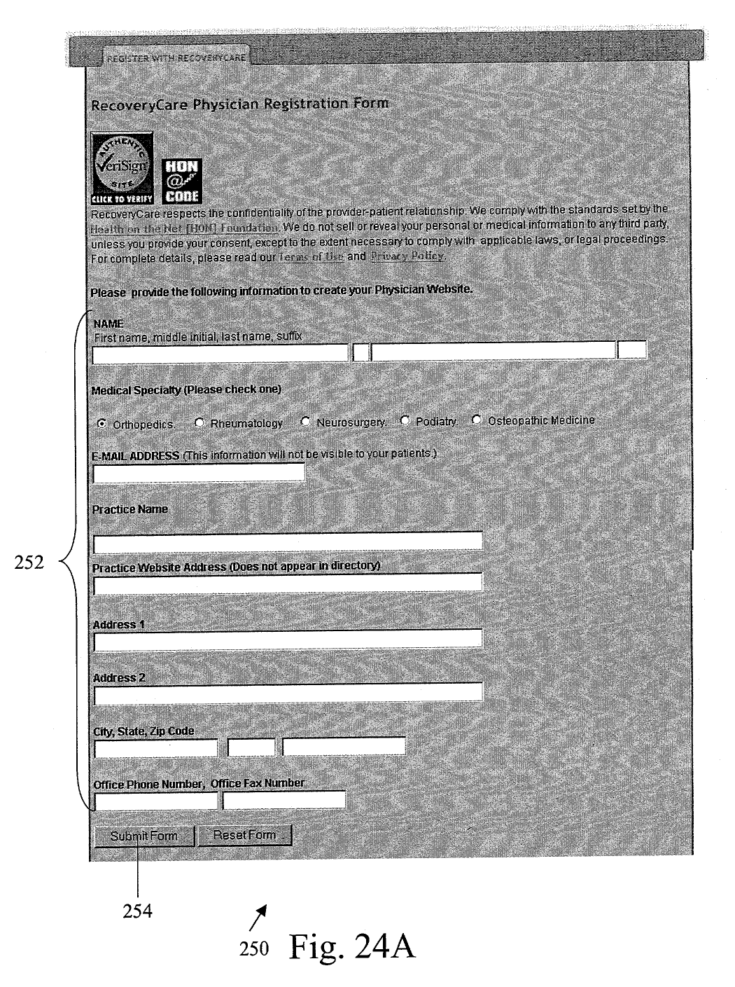

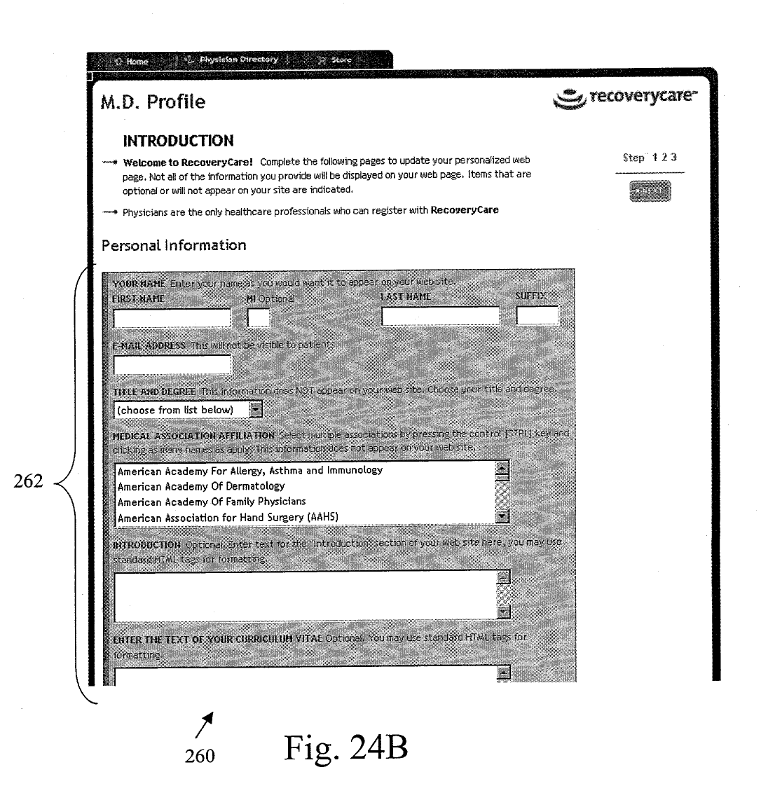

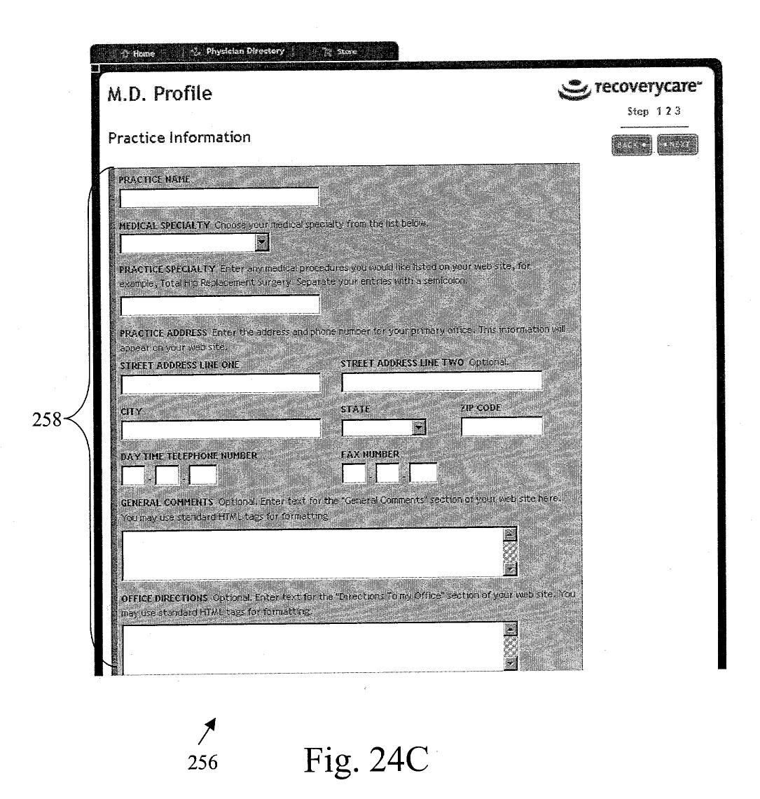

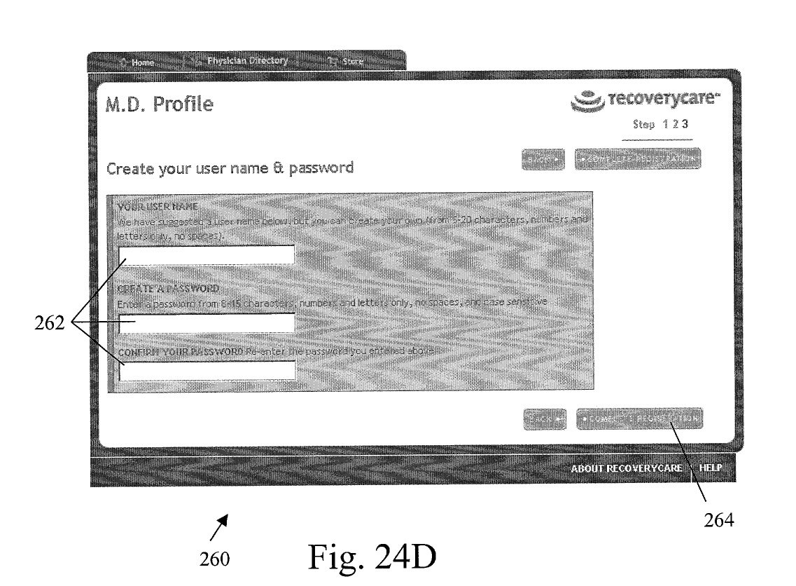

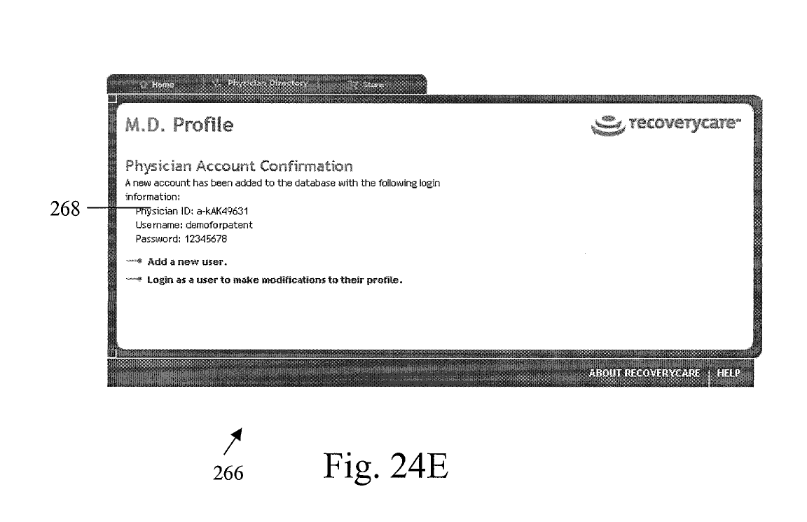

Referring now to FIG. 5 once again, a physician or other practitioner may register and log in to the web implemented embodiment of the present invention as described above by selecting tab 56.2 if the healthcare practitioner is a new user. Upon selection, identification page 86 as shown in FIG. 9A is displayed to the physician. The physician can then select button 87.2 which links to a physician registration form 250 as shown in FIG. 24A. The physician registration form 250 requires entry of various information 252 from the physician and submission of the form by clicking submit button 254. The physician can then create a biographical profile such as that shown in FIG. 6A by completing and submitting numerous forms as discussed in further detail hereinbelow. In particular, the physician may submit a personal information form 260 as shown in FIG. 24B which allows the entry of various biographical information 262. Moreover, the physician can submit his/her practice information utilizing the practice information form 256 as shown in FIG. 24C which allows entry of various information 258 regarding the physician's practice. Lastly, the physician is requested to provide a user name and a password via password page 260 as shown in FIG. 24D which requires the selection and entry of user name and password in fields 262. To complete the registration process, the medical professional clicks on the “completed registration” button 264 upon which an account confirmation page 266 as shown in FIG. 24 is provided to the physician. The confirmation page 266 includes a physician's ID number 268 which the physician can give to his/her patients for logging into and accessing the electronic patient healthcare system in accordance with the present invention. Thus, each patient is associated with a physician through the use of his/her physician's code 268, the significance of which was briefly noted previously and is discussed in further detail below.

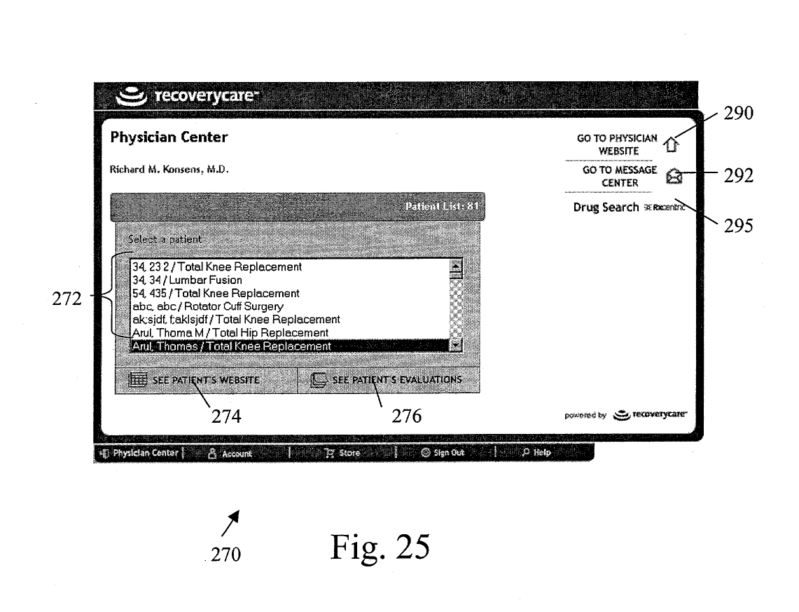

If the physician is a registered user, he/she can log in and access the healthcare information provider system 2 by selecting link 56.1 which is linked to the sign in page 99 shown in FIG. 9F. By entering the user name and the password, the physician can gain access to the healthcare information provider system 2 and access the information therein. In this regard, once a healthcare practitioner has logged into the healthcare information provider system 2, a physician center page 270 as shown in FIG. 25 is displayed. As can be seen, the physician center page 270 provides a scroll down patient list 272 that identifies the physician's patients which has registered to use the electronic patient healthcare system 1 in the manner described previously. As also noted previously, because each patient utilizes the physician's code to access the healthcare information provider system 2 such as the physician's code 268 shown in FIG. 24E, a complete listing of the physician's patient using the electronic patient healthcare system can be provided by cross referencing the registered patient database 17 and the registered practitioner database 18 shown in FIG. 1.

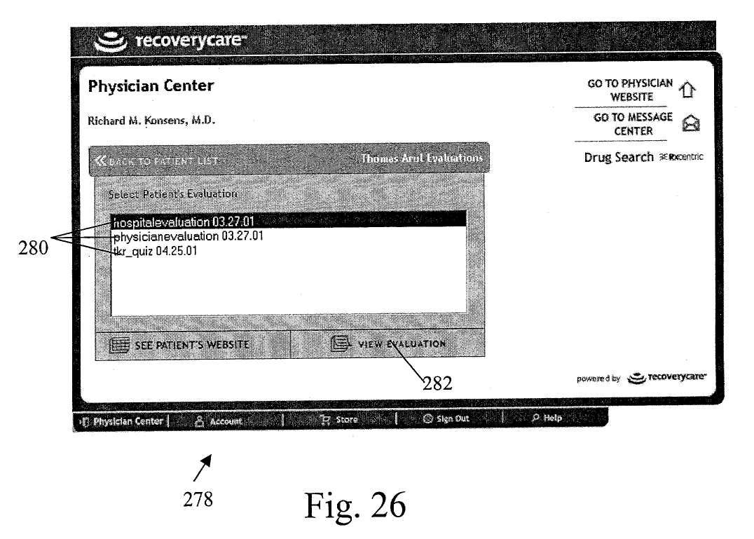

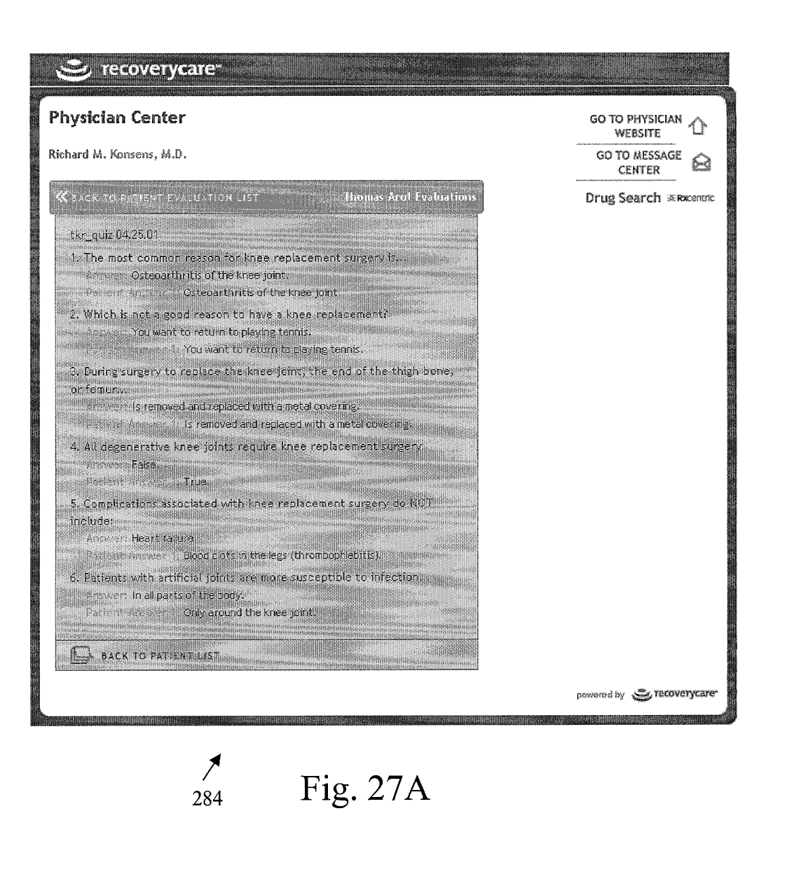

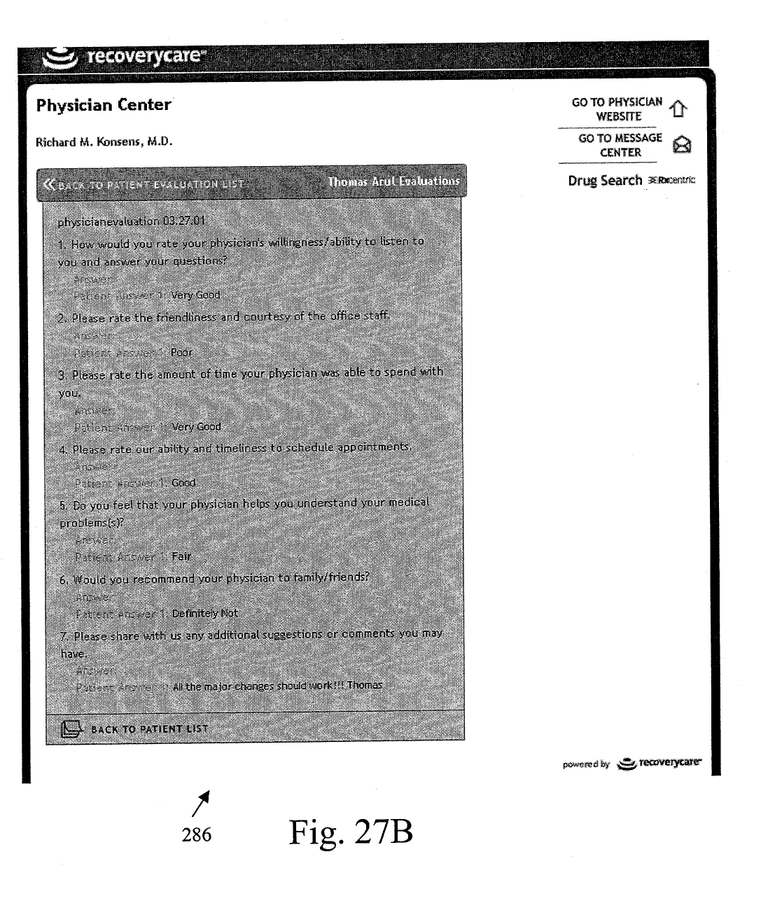

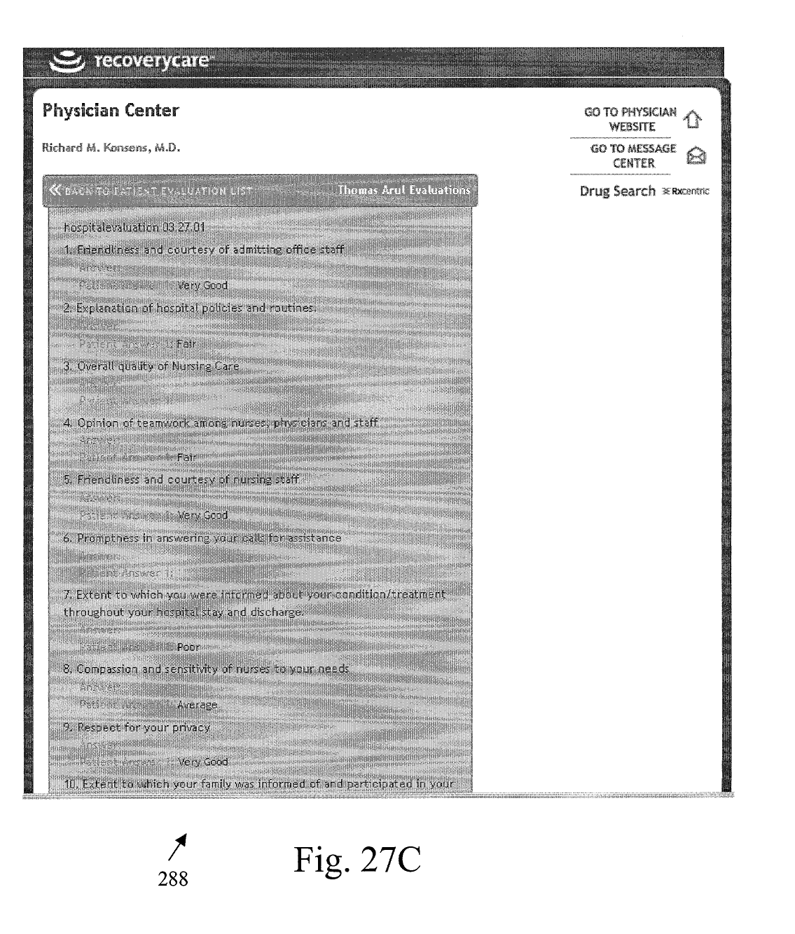

By highlighting a specific patient in the manner shown in FIG. 25, the physician can see the patient's personalized web page (such as that shown in FIG. 10A) by clicking on button 274. In addition, the physician can also access and view evaluations completed by the patient by clicking on button 276. In particular, when the physician selects a particular patient and clicks on button 276, an evaluations list 278 as shown in FIG. 26 is displayed which lists all of the particular patient's evaluations 280. By selecting/highlighting a particular evaluation, and clicking on the “view evaluation” button 282, the responses of the patient with respect to the selected evaluation is displayed for the physician. For instance, if the “tkr_quiz 04.25.01” evaluation is highlighted and viewed by the physician, the patient's response to the self-assessment quiz page 182 of FIG. 16 is displayed as a patient's response page 284 shown in FIG. 27A. As can be seen, the patient response page indicates the question which was posed during the self-assessment quiz, and the patient's answer for the physician's review. As previously noted, this allows the physician to evaluate the patient's knowledge regarding the medical event. In a similar manner, the responses of the patient to the evaluation web page 202 shown in FIG. 18 can also be viewed by the physician by highlighting the evaluation indicated as “physician evaluation 03.27.01” in the evaluations list page 278 and clicking on the “view evaluation” button 282. The corresponding patient response page 286 is shown in FIG. 27B. Likewise, the physician can also view the patient's response to the hospital evaluation page 214 of FIG. 20 by selecting “hospital evaluation 03.27.01” and clicking the “view evaluation” button 282. The corresponding patient response page 288 is shown in FIG. 27C.

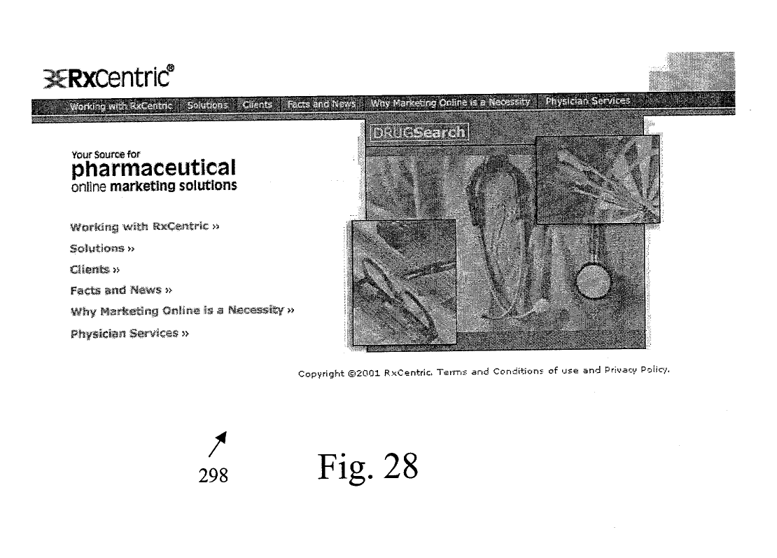

Referring again to FIG. 25, the physician center page 270 may also be provided with a link 290 to the physician's web site and a link 292 for accessing the message center provided by the healthcare information provider system 2 in accordance with the present invention. In particular, the message center may provide e-mail services and a discussion forum in a manner similar to the message center for patients described above in FIGS. 11A-11F, the details of which are omitted here to avoid repetition. Lastly, the physician center home page 270 may also be provided with links that would facilitate the physician's administration of healthcare to his/her patients. For instance, link 295 may be provided on the physician center page 270 which links to a reference page such as reference page 298 shown in FIG. 28 that provides on-line references for the physician's use.

In the above described manner, the present invention provides an electronic patient healthcare system for guiding a patient along a treatment pathway, related to a medical event, by educating and preparing the patient for the medical event and post-event recovery. As discussed in detail relative to FIGS. 1-4, the present invention provides a healthcare information provider system with electronically displayable files for providing to the patient, time-sequenced manner to guide the patient through the medical event one step at a time. As explained, such presentation of tasks and information increases the likelihood of successfully completing the medical event and successfully recovering from the medical event. In addition, one specific example of the present invention as implemented on the Internet has been extensively described relative to FIGS. 5-28. However, the present invention is not limited thereto and may be implemented in different ways.

In this regard, as noted previously, the previously described components of the present invention can be arranged at any location within a communications network for reasons of computation efficiency without effecting the operation of the system. In this regard, part or all of the healthcare information provider system may be provided directly on the medical practitioner's facility. The distributed network 4 may be accessed by a wired or wireless link or any known or later developed element(s) that is capable of supplying and communicating electronic data to and from the healthcare information provider system 2 and the computers 6, and 8.

The methods and systems of this invention can thus be implemented as a program embedded in a computer, dedicated health information system, or the like. More specifically, the healthcare information provider system 2 may be implemented as a separate programmed general purpose computer having a communication device, a special purpose computer, a programmed microprocessor or a microcontroller and peripheral integrated circuit element, an ASIC or other integrated circuit, a digital signal processor, a hardwired or electronic logic circuit such as a discrete element circuit, a programmable logic device, such as a PLD, PLA, FPGA, PAL, or the like. Additionally, the input devices of the computers 6 and 8 can be a keyboard, mouse, speech to text converter, or the like. The display device can be a computer monitor, a display on a PDA, or any other device capable of displaying information to one or more users.

Lastly, the disclosed methods can be readily implemented as software executed on a programmed general purpose computer, a special purpose computer, a microprocessor and associated communications equipment, or the like noted above. Furthermore, the disclosed method may be readily implemented in software using object or object-oriented software development environments that provide portable source code that can be used on a variety of computers, work stations, or modem hardware and/or software platforms. Thus, the present invention may be implemented in a hardware and/or software using any known later developed systems or structures, devices and/or software by those of ordinary skill in the applicable art from the functional description provided herein and with a general basic knowledge of the computer and telecommunications arts.

Thus the present invention permits on-line communication between the patient and the physician while allowing the patient to receive only the information prescribed by his/her physician based on the patient's specific diagnosis and treatment. The present invention essentially creates a patient web site customized to the patient's diagnosis and treatment and capable of being personalized further by the patient. Once signed into the password protected patient web site, the patient has access to various features and functionality including medical information, exercise information, general information related to their hospital stay and/or medical event, general information related to daily living previous to and post surgery, calendar and scheduling of appointments and reminder features, secure electronic communication with their physician, access to a secure discussion are to review and post questions and comments with other registered users, self evaluation quiz for completion and submission to the physician, physician and staff evaluation form for completion and submission to the physician, hospital stay evaluation form, medial profile form for printing and submission to various healthcare providers as required, legal forms, Informed Consent and Advanced Directives, if applicable; duplicate account functionality to provide access to patient's secure web site to family, friends, and other caregivers and access to their physician's RecoveryCare web site.

The present invention also provides the physician with various features and functionality including on-line communication with their patient, a unique security code to provide to patients for accessing the on-line educational materials and other files specific to the patient's diagnosis and treatment; a secure password protected web site area, i.e. physician center, to communicate with and review patient usage of the system and responses; a patient listing of all registered users which sign in to the system using the unique physician security code, access to a secure discussion area to review and post questions and comments with other registered users, access to the patient's web site to review and make changes, notes, etc., directly to the patient's web site; a self evaluation quiz completed by the patient to test their knowledge of their medical situation; the completed physician and staff evaluation form submitted by the patient; the hospital stay evaluation form completed by the patient; and a link to access their RecoveryCare physician web site.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. An electronic patient healthcare system for guiding a patient along a treatment pathway, related to a medical event, by educating and preparing the patient for the medical event and post-event recovery, comprising:
a healthcare information provider system including a storage device and electronically displayable files containing health information associated with the medical event and retrievably stored on said storage device, the storage device further including a registered patient database for storing information regarding patients being guided by the electronic patient healthcare system and a registered practitioner database for storing information regarding practitioners treating the patients being guided by the electronic patient healthcare system; and
a patient terminal device in electronic communication with said healthcare information provider system and including an input device and a display device adapted to display said electronically displayable files;
wherein said electronically displayable files include at least one pre-event set of electronically displayable files containing health information for preparing and educating the patient for the medical event, and at least one post-event set of electronically displayable files containing health information for preparing and educating the patient for post-event recovery so as to guide the patient along the treatment pathway, at least one of the pre-event and post-event sets of files including a task file that instructs the patient to perform a predetermined task, the predetermined task including at least two of scheduling an appointment with a medical professional, purchasing a medical product, taking a medical quiz, and evaluating at least one of a medical practitioner and a medical service facility.

2. The system of claim 1, wherein said electronically displayable files include a single electronically displayable file including a treatment pathway timeline display, said single electronic displayable file including a treatment pathway timeline display comprising a plurality of time-sequenced phase images corresponding to time-sequenced phases of health information thereby illustrating the treatment pathway.

3. The system of claim 2, wherein each of said plurality of time-sequenced phase images include at least one electronic link to one of the pre-event set of files and the post-event set of files, and the patient can access the health information of a particular time-sequenced phase by interacting with the corresponding time-sequenced phase image.

4. The system of claim 1, wherein the task file includes a patient confirmation subfile that requires the patient to interactively confirm completion of the predetermined task using the input device of the patient terminal device and communicate the confirmation with the healthcare information provider system.

5. The system of claim 1, wherein at least one of the pre-event and post-event sets of files includes a calendar file that displays a schedule of time specific events associated with the treatment pathway, said calendar file adapted to be modified by the patient using the input device of the patient terminal device.

6. The system of claim 1, further including an electronically displayable duplicate account file containing input fields for receiving account information relating to an authorized user to create a duplicate account for permitting the authorized user to access and modify the patient's treatment pathway.

7. The system of claim 1, wherein each of a patient's time-sequenced phase images is adapted to be modified by a medical practitioner treating the patient being guided by the electronic patient healthcare system.

8. A system for displaying health information capable of guiding a patient along a treatment pathway, related to a medical event, by educating and preparing the patient for the medical event and post-event recovery, comprising:
a healthcare information provider system including a storage device and electronically displayable files containing health information associated with the medical event and retrievably stored on said storage device; and
a patient terminal device including an input device and a display device adapted to display said electronically displayable files;
wherein said electronically displayable files include a single electronically displayable file including a treatment pathway timeline display comprising a plurality of time-sequenced phase images corresponding to time-sequenced phases of health information, each of said time-sequenced phase images providing access to at least one of a pre-event set of electronically displayable files containing health information for preparing and educating the patient for the medical event and a post-event set of electronically displayable files containing health information for preparing and educating the patient for post-event recovery so as to guide the patient along the treatment pathway.

9. The system of claim 8, wherein each of said plurality of time-sequenced phase images include at least one electronic link to one of the pre-event set of files and the post-event set of files, and the patient can access the health information of a particular time-sequenced phase by interacting with the corresponding time-sequenced phase image.

10. The system of claim 8, wherein at least one of the pre-event and post-event sets of files includes a task file that instructs the patient to perform a predetermined task.

11. The system of claim 8, wherein the predetermined task includes at least three of reading a medical information file, taking medication, scheduling an appointment with a medical professional, purchasing a medical product, taking a medical quiz, and evaluating at least one of a medical practitioner and a medical service facility.

12. The system of claim 8, wherein the predetermined task includes at least two of scheduling an appointment with a medical professional, purchasing a medical product, taking a medical quiz, and evaluating at least one of a medical practitioner and a medical service facility.

13. A method for guiding a patient along a treatment pathway associated with a medical event by providing health information to educate and prepare the patient for the medical event and post-event recovery, comprising the steps of:
generating, based on the medical event of the patient, at least one pre-event set of electronically displayable files containing health information for preparing and educating the patient for the medical event, and at least one post-event set of electronically displayable files containing health information for preparing and educating the patient for post-event recovery;
displaying a single electronically displayable file including a treatment pathway timeline display comprising a plurality of time-sequenced phase images corresponding to time-sequenced phases of health information to illustrate the treatment pathway, each of said time-sequenced phase images providing access to at least one of a pre-event set of electronically displayable files containing health information for preparing and educating the patient for the medical event and a post-event set of electronically displayable files containing health information for preparing and educating the patient for post-event recovery so as to guide the patient along the treatment pathway; and
permitting the patient to view the treatment pathway timeline display and access the health information of a particular time-sequenced phase by interacting with the corresponding time-sequenced phase image.

14. The method of claim 13, further including the steps of providing the patient with a medical practitioner code designating the medical practitioner conducting the medical event and requiring the patient to input the medical practitioner code into an electronically displayable file containing a code input field and transmitting the code to the healthcare information provider system.

15. The method of claim 13, wherein at least one of the pre-event and post-event sets of files includes a task file that instructs the patient to perform a predetermined task.

16. The method of claim 15, wherein the predetermined task includes at least three of reading a medical information file, taking medication, scheduling an appointment with a medical professional, purchasing a medical product, taking a medical quiz, and evaluating at least one of a medical practitioner and a medical service facility.

17. The method of claim 13, wherein at least one of the pre-event and post-event sets of files includes a calendar file that displays a schedule of time specific events associated with the treatment pathway, said calendar file adapted to be modified by the patient using the input device of the patient terminal device.

18. The method of claim 13, further including the step of providing an electronically displayable duplicate account file containing input fields for receiving account information relating to an authorized user to create a duplicate account for permitting the authorized user to access and modify the patient's treatment pathway.

19. An information storage media, comprising:
instructions for generating, based on the medical event of the patient, at least one pre-event set of electronically displayable files containing health information for preparing and educating the patient for the medical event, and at least one post-event set of electronically displayable files containing health information for preparing and educating the patient for post-event recovery;
instructions for displaying a single electronically displayable file including a treatment pathway timeline display comprising a plurality of time-sequenced phase images corresponding to time-sequenced phases of health information to illustrate the treatment pathway, each of said time-sequenced phase images providing access to at least one of a pre-event set of electronically displayable files containing health information for preparing and educating the patient for the medical event and a post-event set of electronically displayable files containing health information for preparing and educating the patient for post-event recovery so as to guide the patient along the treatment pathway; and
instructions for generating and displaying an access file for permitting the patient to view the treatment pathway timeline display and access the health information of a particular time-sequenced phase by interacting with the corresponding time-sequenced phase image.

20. The information storage media of claim 19, further including instructions providing an electronically displayable file containing a code input field for receiving a medical practitioner code and transmitting the code to the healthcare information provider system.

21. The information storage media of claim 20, wherein at least one of the pre-event and post-event sets of files includes a task file that instructs the patient to perform a predetermined task.

22. The information storage media of claim 21, wherein the predetermined task includes at least three of reading a medical information file, taking medication, scheduling an appointment with a medical professional, purchasing a medical product, taking a medical quiz, and evaluating at least one of a medical practitioner and a medical service facility.

22. The information storage media of claim 20, wherein at least one of the pre-event and post-event sets of files includes a calendar file that displays a schedule of time specific events associated with the treatment pathway, said calendar file adapted to be modified by the patient using the input device of the patient terminal device.

23. The information storage media of claim 20, further including instructions for displaying an electronically displayable duplicate account file containing input fields for receiving account information relating to an authorized user to create a duplicate account for permitting the authorized user to access and modify the patient's treatment pathway.
